(19) United States
(12) Patent Application Publication
(10) Pub. No.: US 2026/0172929 A1
(43) Pub. Date: Jun. 18, 2026

(54) NETWORK NODE AND METHODS FOR ENHANCED SECONDARY NODE MODIFICATION IN DUAL CONNECTIVITY

(71) Applicant: Telefonaktiebolaget LM Ericsson (publ), Stockholm (SE)

(72) Inventors: Bokyung BYUN, Suwon-si, Gyeonggi-do (KR); Sangho LEE, Gwacheon-si, Gyeonggi-do (KR)

(73) Assignee: Telefonaktiebolaget LM Ericsson (publ), Stockholm (SE)

(21) Appl. No.: 19/126,578

(22) PCT Filed: Oct. 30, 2023
(86) PCT No.: PCT/EP2023/080192

§ 371 Date: May 1, 2025

(30) Foreign Application Priority Data
Nov. 3, 2022 (WO) PCT/EP2022/080659

(51) Int. Cl. H04W 36/08; H04L 5/00; H04W 36/00; H04W 76/20; H04W 92/20

(52) U.S. Cl. CPC H04W 36/08; H04L 5/0053; H04W 36/0069; H04W 76/20; H04W 92/20

(57) ABSTRACT

Network node and method for enhanced secondary node modification in dual connectivity are disclosed. A method (1900) performed by a second network node (200) includes optionally including (S1902), in a Secondary Node (SN) Modification Request Acknowledge message, an indication indicating that information on whether a User Equipment (UE) reconfiguration of a UE (100) is successful is required from a first network node; and sending (S1904) the SN Modification Request Acknowledge message to the first network node. The first network node and the second network node (200) comprise a master node (MN) and a secondary node (SN), respectively, in dual connectivity with the UE (100).

### TECHNICAL FIELD

Embodiments of the present disclosure are directed to wireless communications and, more particularly, to enhanced secondary node modification in dual connectivity.

### BACKGROUND

5G NR (New Radio technology) is the 5th generation cellular mobile system that provides improved performance related to data rate, coverage and capacity compared to legacy 4G LTE systems.

Today 5G (NR) service is provided as NSA (Non-standalone) mode or SA (Standalone) mode, where in NSA mode, 5G subscription users connect to 4G Master node first, and then connect to 5G Secondary node by using dual-connectivity technology, which is called as EN-DC (Eutra-NR Dual Connectivity). Meanwhile in SA mode, 5G subscription users connect to 5G Master node, and then optionally connect to 5G Secondary node by using dual-connectivity technology, which is called as NR-DC (NR-NR Dual Connectivity).

3GPP TS 37.340 stage 2 specification (Evolved Universal Terrestrial Radio Access (E-UTRA) and NR; Multi-connectivity) defines the overall dual connectivity procedures describing the Secondary Node Addition, Modification, Change and Release procedures.

3GPP TS 36.423 stage 3 (X2 application protocol (X2AP)) and 3GPP TS 38.423 stage 3 (Xn application protocol (XnAP)) specification describe the X2/Xn procedures with regard to the dual connectivity message handling between Master node and Secondary node.

Taking the EN-DC scenario as an example, configuration modification of User Equipment (UE) context by the MN is performed through a MeNB-initiated SgNB modification procedure. In more detail, when the MN wants to change configuration of the UE, the MN informs the SN of the reconfiguration information to be updated through X2 interface and transmits the information to the UE via RRCConnectionReconfiguration message. Upon receiving this RRC message, the UE applies the received configuration and sends RRCConnectionReconfigurationComplete message indicating that the updated configuration has been successfully completed. Through this response message, the MN recognizes that the UE will operate in an updated configuration. The MN informs the SN of the successful reconfiguration of the UE through the X2 SgNBReconfigurationComplete message. However, it is not clearly stated in current technical specification when the MeNB should send SgNBReconfigurationComplete message to the SgNB. If the message is not sent in time, the SN may not recognize the successful reconfiguration of the UE. As a result, the the MeNB and the SgNB may have different understanding of the UE context, and this results in unintended operation. For example, each node may perform additional signaling to verify the understanding of each other's UE context, or the UE may receive poor service with lower throughput as EN-DC is released, or the UE may be released in the worst case and no longer be able to receive any service.

Same problems may also occur in other DC scenarios, such as NR-DC.

There is thus a need for addressing at least the above problems.

### REFERENCES

[1] 3GPP TS 36.423 E-UTRAN; X2 application protocol (X2AP);
[2] 3GPP TS 37.340 E-UTRA and NR; Multi-connectivity Stage 2;
[3] 3GPP TS 38.331 NR; Radio Resource Control (RRC) protocol specification;
[4] 3GPP TS 36.331 E-UTRA; Radio Resource Control (RRC) Protocol specification;
[5] 3GPP TS 38.423 NG-RAN; Xn application protocol (XnAP);
[6] 3GPP TS 38.401 NG-RAN; Architecture description;
[7] O-RAN ALLIANCE TS O-RAN Architecture Description 7.0.

### SUMMARY

Based on the above, certain challenges currently exist with SN modification procedure in dual connectivity. Certain aspects of the present disclosure and their embodiments may provide solutions to these or other challenges.

According to some embodiments of the present disclosure, a method performed by a second network node may comprise: optionally including, in a Secondary Node (SN) Modification Request Acknowledge message, an indication indicating that information on whether a User Equipment (UE) reconfiguration of a UE is successful is required from a first network node; and sending the SN Modification Request Acknowledge message to the first network node. The first network node and the second network node may comprise a master node (MN) and a secondary node (SN), respectively, in dual connectivity with the UE.

According to some embodiments of the present disclosure, a method performed by a first network node may comprise: receiving a SN Modification Request Acknowledge message from a second network node; and checking whether an indication indicating that information on whether a UE reconfiguration of a UE is successful is required from the first network node is included in the SN Modification Request Acknowledge message. The first network node and the second network node may comprise a MN and a SN and a master node (MN), respectively, in dual connectivity with the UE.

According to some embodiments of the present disclosure, a network node may comprises one or more processors, and memory storing instructions that, when executed by the one or more processors, cause the network node to perform any one of the above methods.

According to some embodiments of the present disclosure, a computer-readable storage medium may be provided having computer-readable instructions stored therein, the computer-readable instructions, when executed by a processor of a network node, configure the network node to perform any one of the above methods.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a schematic diagram of a dual connectivity overall architecture;

FIG. 2 is a schematic block diagram of a UE according to some embodiments of the present disclosure;

FIG. 3 is a schematic block diagram of a network node according to some embodiments of the present disclosure;

FIG. 4 shows an example signaling flow for an MN initiated SN Modification procedure in the EN-DC scenario;

FIG. 5 shows an example signalling flow for an SN initiated SgNB Modification procedure with MN involvement in the EN-DC scenario;

FIG. 6 shows an example signalling flow for SN initiated SN modification procedure without MN involvement in the EN-DC scenario;

FIG. 7 shows an example signalling flow for SN initiated SN Modification without MN involvement and with SRB3 being used to configure CPC in the EN-DC scenario;

FIG. 8 shows an example signalling flow for transfer of an NR RRC message to/from the UE when SRB3 is not used in the EN-DC scenario;

FIG. 9 shows an example signalling flow for SN initiated SN Modification procedure without MN involvement and without SRB3 being used to configure CPC in the EN-DC scenario;

FIG. 10 shows an example signalling flow for an MN initiated SN Modification procedure;

FIG. 11 shows an example signalling flow for an SN initiated SN Modification procedure;

FIG. 12 shows an example signalling flow for an SN initiated SN modification procedure without MN involvement;

FIG. 13 shows an example signalling flow for an SN initiated SN Modification without MN involvement and with SRB3 being used to configure CPC;

FIG. 14 shows an example signalling flow for transfer of an NR RRC message to/from the UE;

FIG. 15 shows an example signalling flow for an SN initiated SN Modification without MN involvement and SRB3 is not used to configure CPC;

FIG. 16 shows a SgNB Reconfiguration Complete procedure with successful operation;

FIG. 17 shows a MeNB initiated SgNB Modification Preparation with successful operation;

FIG. 18 shows a MeNB initiated SgNB Modification Preparation with unsuccessful operation;

FIG. 19 is a flowchart illustrating a method performed in a network node according to some embodiments of the present disclosure;

FIG. 20 is a flowchart illustrating a method performed in a network node according to some embodiments of the present disclosure;

FIG. 21 shows a legacy flow of the MN initiated SN Modification procedure in the EN-DC scenario as shown in FIG. 4;

FIG. 22 shows an example flow of an MN initiated SN Modification procedure in the EN-DC scenario according to some embodiments of the present disclosure;

FIG. 23 shows another example flow of an MN initiated SN Modification procedure in the EN-DC scenario according to some embodiments of the present disclosure;

FIG. 24 shows signalling between UE, MeNB and SgNB in an SN modification procedure according to some embodiments of the present disclosure;

FIG. 25 is a schematic diagram of gNB split deployment in cloud implementation in which some embodiments of the present disclosure may be applied; and

FIG. 26 is a schematic diagram of O-RAN implementation in which some embodiments of the present disclosure may be applied.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Examples of network nodes include NodeB, base station (BS), multi-standard radio (MSR) radio node such as MSR BS, eNodeB, gNodeB, MeNB, SeNB, location measurement unit (LMU), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB),

Baseband Unit, Centralized Baseband, C-RAN, access point (AP), transmission points, transmission nodes, transmission reception point (TRP), RRU, RRH, nodes in distributed antenna system (DAS), core network node (e.g. MSC, MME etc.), O&M, OSS, SON, positioning node (e.g. E-SMLC), etc.

The non-limiting term UE refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, PDA, tablet, mobile terminals, smart phone, laptop embedded equipment (LEE), laptop mounted equipment (LME), USB dongles, etc.

The term radio access technology, or RAT, may refer to any RAT e.g. UTRA, E-UTRA, narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The term signal or radio signal used herein can be any physical signal or physical channel. Examples of downlink physical signals are reference signal (RS) such as PSS, SSS, CSI-RS, DMRS signals in SS/PBCH block (SSB), discovery reference signal (DRS), CRS, PRS, etc. RS may be periodic, e.g., RS occasion carrying one or more RSs may occur with certain periodicity, e.g., 20 ms, 40 ms, etc. The RS may also be aperiodic.

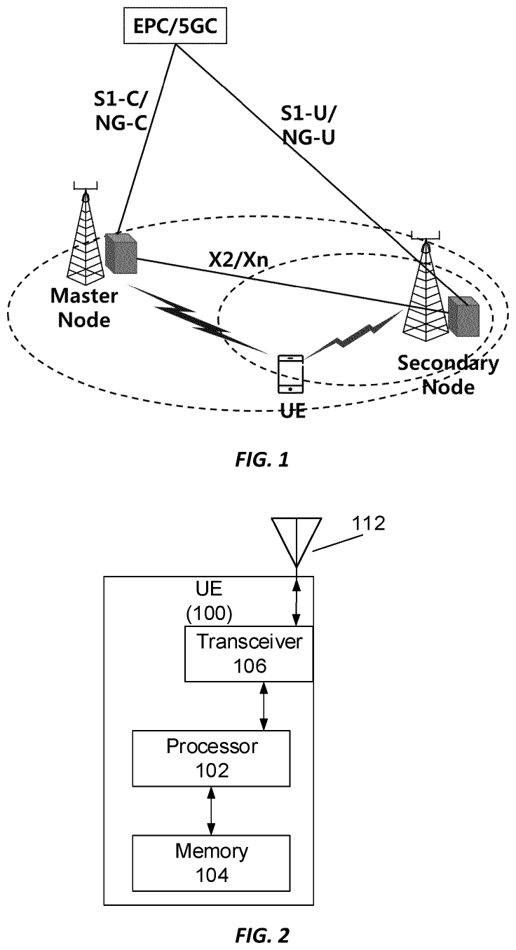

FIG. 1 is a schematic diagram of a dual connectivity overall architecture. As shown in FIG. 1, the UE connects to a master node (MN) and a secondary node (SN) using dual-connectivity technology. The dual connectivity may be any type of MR-DC (Multi-Radio Dual Connectivity), and the MN and SN each may be any type of network nodes communicating with X2/Xn messages configured for dual connectivity. The MN and SN may connect to EPC (Evolved Packet Core)/5GC (5G Core) networks over interfaces like S1-C/NG-C, and S1-U/NG-U. Embodiments described here may be applied in the dual connectivity architecture.

FIG. 2 is a schematic block diagram of UE according to some embodiments of the present disclosure. The UE 100 may act as the UE shown in FIG. 1. As illustrated, the UE 100 includes one or more processors 102 (e.g., CPUs, ASICs, FPGAs, and/or the like), memory 104, and one or more transceivers 106 each including one or more transmitters and one or more receivers coupled to one or more antennas 112. The transceiver(s) 106 includes radio-front end circuitry connected to the antenna(s) 112 that is configured to condition signals communicated between the antenna(s) 112 and the processor(s) 102, as will be appreciated by on of ordinary skill in the art. The processors 102 are also referred to herein as processing circuitry. The transceivers 106 are also referred to herein as radio circuitry. In some embodiments, the functionality of the UE 100 described herein may be fully or partially implemented in software that is, e.g., stored in the memory 104 and executed by the processor(s) 102. Note that the UE 100 may include additional components not illustrated in FIG. 2 such as, e.g., one or more user interface components (e.g., an input/output interface including a display, buttons, a touch screen, a microphone, a speaker(s), and/or the like and/or any other components for allowing input of information into the UE 100 and/or allowing output of information from the UE 100), a power supply (e.g., a battery and associated power circuitry), etc.

In some embodiments, a computer program is provided to include instructions which, when executed by at least one processor, causes the at least one processor to carry out the functionality of the UE 100 according to any of the embodiments described herein, for example, one or more of the steps included in methods to be described later. In some embodiments, a carrier comprising the aforementioned computer program product is provided. The carrier is one of an electronic signal, an optical signal, a radio signal, or a computer readable storage medium (e.g., a non-transitory computer readable medium such as memory).

In some embodiments, the UE 100 may include one or more modules, each of which is implemented in software. The module(s) provide the functionality of the UE 100 according to any of the embodiments described herein.

FIG. 3 is a schematic block diagram of a network node according to some embodiments of the present disclosure. The network node 100 may act as any one of the MN and SN shown in FIG. 1. As illustrated, the network node 200 includes one or more processors 202 (e.g., CPUs, ASICs, FPGAs, and/or the like), memory 204, one or more transceivers 206 each including one or more transmitters and one or more receivers coupled to one or more antennas 212, and network interface 214. The transceiver(s) 206 includes radio-front end circuitry connected to the antenna(s) 212 that is configured to condition signals communicated between the antenna(s) 212 and the processor(s) 202, as will be appreciated by on of ordinary skill in the art. The processors 202 are also referred to herein as processing circuitry. The transceivers 206 are also referred to herein as radio circuitry. The network interface 214 may be configured to provide communications with other network nodes and/or core network. In some embodiments, the functionality of the network node 200 described herein may be fully or partially implemented in software that is, e.g., stored in the memory 204 and executed by the processor(s) 202. Note that the network node 200 may include additional components not illustrated in FIG. 3, such as a power supply and associated power circuitry, etc.

In some embodiments, a computer program is provided to include instructions which, when executed by at least one processor, causes the at least one processor to carry out the functionality of the network node 200 according to any of the embodiments described herein, for example, one or more of the steps included in methods to be described later. In some embodiments, a carrier comprising the aforementioned computer program product is provided. The carrier is one of an electronic signal, an optical signal, a radio signal, or a computer readable storage medium (e.g., a non-transitory computer readable medium such as memory).

In some embodiments, the network node 200 includes one or more modules, each of which is implemented in software. The module(s) provide the functionality of the network node 200 according to any of the embodiments described herein.

In the following, a “Secondary Node Modification procedure” from 3GPP TS 37.340 and “MeNB initiated SgNB Modification Preparation” from 3GPP TS 36.423 will be described respectively. Note that 3GPP TS 38.423 contents are mostly similar with 3GPP TS 36.423.

### Secondary Node Modification Procedure

3GPP TS 37.340 Section 10.3 describes the Secondary Node Modification procedure is initiated by the MN or SN. Section 10.3.1 is for EN-DC and 10.3.2 is for NR-DC (or called as MR-DC (Multi-Radio Dual Connectivity).

### 10.3 Secondary Node Modification (MN/SN Initiated)

### 10.3.1 EN-DC

The Secondary Node Modification procedure may be initiated either by the MN or by the SN and be used to modify, establish or release bearer contexts, to transfer bearer contexts to and from the SN or to modify other properties of the UE context within the same SN. It may also be used to transfer an NR RRC message from the SN to the UE via the MN and the response from the UE via MN to the SN (e.g. when SRB3 is not used). In case of CPC (Conditional PSCell Change), this procedure is used to configure or modify CPC configuration within the same SN.

The Secondary Node modification procedure does not necessarily need to involve signalling towards the UE.

### MN Initiated SN Modification

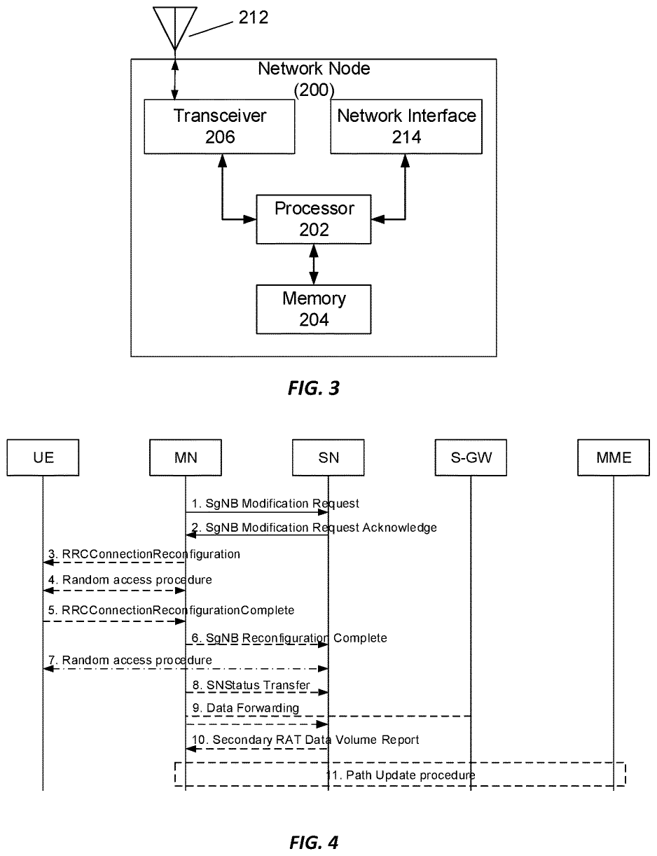

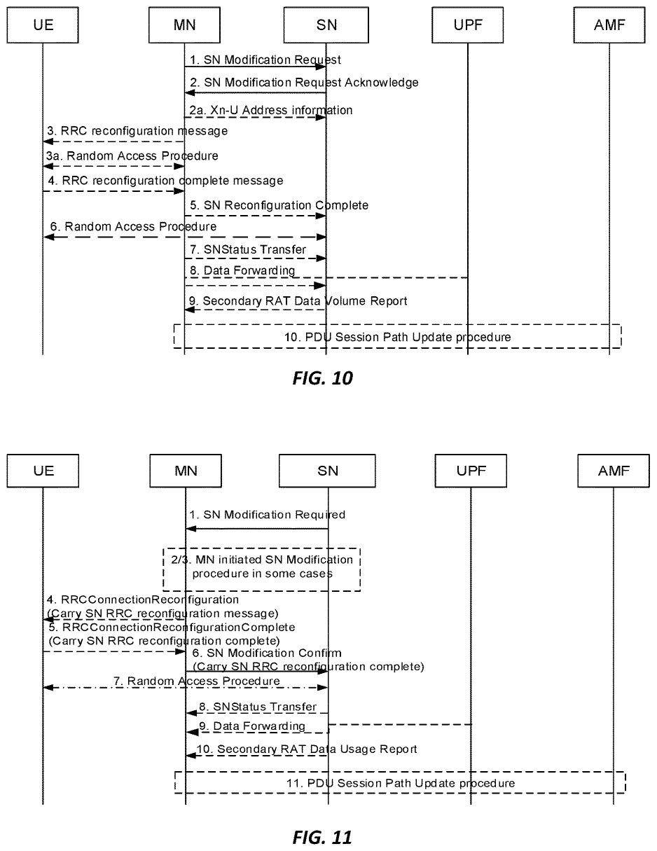

The MN uses the procedure to initiate configuration changes of the SCG (Secondary Cell Group) within the same SN, e.g. the addition, modification or release of SCG bearer(s) and the SCG RLC bearer of split bearer(s), as well as configuration changes for SN terminated MCG (Master Cell Group) bearers. Bearer termination point change is realized by adding the new bearer configuration and releasing the old bearer configuration within a single MN initiated SN Modification procedure for the respective E-RAB. The MN uses this procedure to perform handover within the same MN while keeping the SN. The MN also uses the procedure to query the current SCG configuration, e.g. when delta configuration is applied in an MN initiated SN change. The MN also uses the procedure to provide the S-RLF related information to the SN. The MN may not use the procedure to initiate the addition, modification or release of SCG SCells. The SN may reject the request, except if it concerns the release of SN terminated bearer(s) or the SCG RLC bearer of MN terminated bearer(s), or if it is used to perform handover within the same MN while keeping the SN. FIG. 4 (i.e., FIG. 10.3.1-1 in Section 10.3.1) shows an example signalling flow for an MN initiated SN Modification procedure.
1. The MN sends the SgNB Modification Request message, which may contain bearer context related or other UE context related information, data forwarding address information (if applicable) and the requested SCG configuration information, including the UE capability coordination result to be used as basis for the reconfiguration by the SN. In case a security key update in the SN is required, a new SgNB Security Key is included. In case of SCG RLC re-establishment for E-RABs configured with an MN terminated bearer with an SCG RLC bearer for which no bearer type change is performed, the MN provides a new UL GTP tunnel endpoint to the SN. The SN shall continue sending UL PDCP PDUs to the MN with the previous UL GTP tunnel endpoint until it re-establishes the RLC and use the new UL GTP tunnel endpoint after re-establishment. In case of PDCP re-establishment for E-RABs configured with an SN terminated bearer with an MCG RLC bearer for which no bearer type change is performed, the MN provides a new DL GTP tunnel endpoint to the SN. The SN shall continue sending DL PDCP PDUs to the MN with the previous DL GTP tunnel endpoint until it performs PDCP re-establishment and use the new DL GTP tunnel endpoint starting with the PDCP re-establishment.
2. The SN responds with the SgNB Modification Request Acknowledge message, which may contain SCG radio resource configuration information within a NR RRC configuration message and data forwarding address information (if applicable). In case of a security key update (with or without PSCell change), for E-RABs configured with the MN terminated bearer option that require X2-U resources between the MN and the SN, for which no bearer type change is performed, the SN provides a new DL GTP tunnel endpoint to the MN. The MN shall continue sending DL PDCP PDUs to the SN with the previous DL GTP tunnel endpoint until it performs PDCP re-establishment or PDCP data recovery, and use the new DL GTP tunnel endpoint starting with the PDCP re-establishment or data recovery. In case of a security key update (with or without PSCell change), for E-RABs configured with the SN terminated bearer option that require X2-U resources between the MN and the SN, for which no bearer type change is performed, the SN provides a new UL GTP tunnel endpoint to the MN. The MN shall continue sending UL PDCP PDUs to the SN with the previous UL GTP tunnel endpoint until it re-establishes the RLC and use the new UL GTP tunnel endpoint after re-establishment.
NOTE 00: In case SN includes the indication of full RRC configuration in SgNB Modification Request Acknowledge message to MN e.g. comprehension failure upon intra-CU inter-DU change, MN performs release and add of the NR SCG part of the configuration but does not release SN terminated radio bearers towards the UE.
3-5. The MN initiates the RRC connection reconfiguration procedure, including the NR RRC configuration message. The UE applies the new configuration, synchronizes to the (if instructed, in case of intra-MN handover) and replies with RRCConnectionReconfigurationComplete, including a NR RRC response message, if needed. In case the UE is unable to comply with (part of) the configuration included in the RRCConnectionReconfiguration message, it performs the reconfiguration failure procedure.
6. Upon successful completion of the reconfiguration, the success of the procedure is indicated in the SgNB Reconfiguration Complete message.
7. If instructed, the UE performs synchronisation towards the PSCell of the SN as described in SgNB addition procedure. Otherwise, the UE may perform UL transmission after having applied the new configuration.
8. If PDCP termination point is changed for bearers using RLC AM, and when RRC full configuration is not used, the SN Status Transfer takes place between the MN and the SN (FIG. 4 depicts the case where a bearer context is transferred from the MN to the SN).
NOTE 0: The SN may not be aware that a SN terminated bearer requested to be released is reconfigured to a MN terminated bearer. The SN Status for the released SN terminated bearers with RLC AM may also be transferred to the MN.
9. If applicable, data forwarding between MN and the SN takes place (FIG. 4 depicts the case where a bearer context is transferred from the MN to the SN).
10. The SN sends the Secondary RAT Data Usage Report message to the MN and includes the data volumes delivered to and received from the UE over the NR radio for the E-RABs to be released and for the E-RABs for which the S1 UL GTP Tunnel endpoint was requested to be modified.
NOTE 1: The order the SN sends the Secondary RAT Data Usage Report message and performs data forwarding with MN is not defined. The SN may send the report when the transmission of the related bearer is stopped.
11. If applicable, a path update is performed.
   SN Initiated SN Modification with MN Involvement

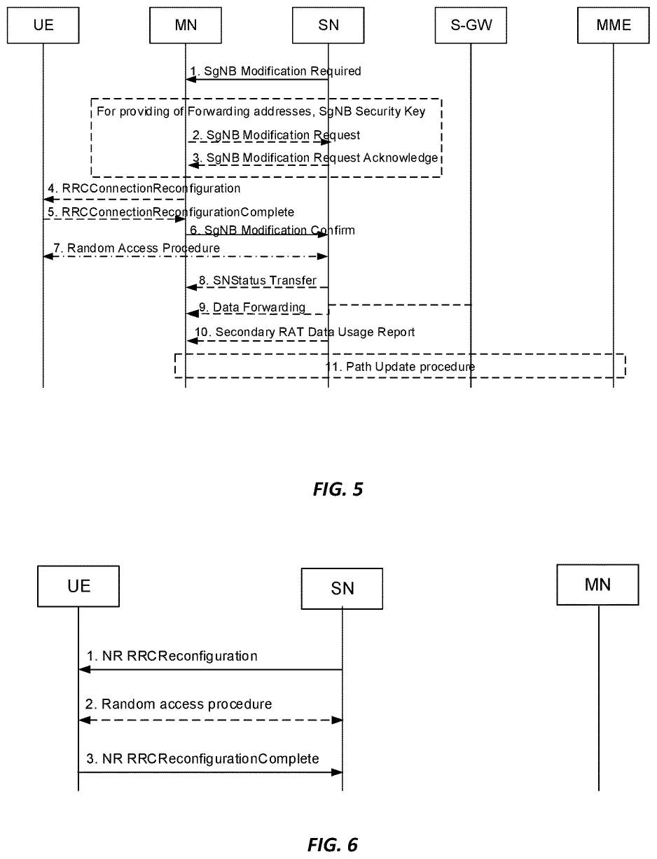

The SN uses the procedure to perform configuration changes of the SCG within the same SN, e.g. to trigger the release of SCG bearer(s) and the SCG RLC bearer of split bearer(s) (upon which the MN may release the bearer or maintain current bearer type or reconfigure it to an MCG bearer, either MN terminated or SN terminated), and to trigger PSCell change (e.g. when a new security key is required or when the MN needs to perform PDCP data recovery). The MN cannot reject the release request of SCG bearer and the SCG RLC bearer of a split bearer. The MN shall either accept modification of all of the requested SCG bearer(s) and the SCG RLC bearer of split bearer(s), or fail the procedure. FIG. 5 (i.e., FIG. 10.3.1-2 in Section 10.3.1) shows an example signalling flow for an SN initiated SgNB Modification procedure, with MN involvement.
1. The SN sends the SgNB Modification Required message including a NR RRC configuration message, which may contain bearer context related, other UE context related information and the new SCG radio resource configuration. For bearer release or modification, a corresponding E-RAB list is included in the SgNB Modification Required message. In case of change of security key, the PDCP Change Indication indicates that a S-KgNB update is required. In case the MN needs to perform PDCP data recovery, the PDCP Change Indication indicates that PDCP data recovery is required.

The SN can decide whether the change of security key is required.
NOTE 1a: In case SN includes the indication of full RRC configuration in SgNB Modification Required message to MN e.g. comprehension failure upon intra-CU inter-DU change, MN performs release and add of the NR SCG part of the configuration but does not release SN terminated radio bearers towards the UE.
2/3. The MN initiated SN Modification procedure may be triggered by the SN Modification Required message (e.g. to provide information such as data forwarding addresses, new SN security key, measurement gap, etc. . . . )
NOTE 2: If only SN security key is provided in step 2, the MN does not need to wait for the reception of step 3 to initiate the RRC connection reconfiguration procedure.
4. The MN sends the RRCConnectionReconfiguration message including a NR RRC configuration message to the UE including the new SCG radio resource configuration.
5. The UE applies the new configuration and sends the RRCConnectionReconfigurationComplete message, including an encoded NR RRC response message, if needed. In case the UE is unable to comply with (part of) the configuration included in the RRCConnectionReconfiguration message, it performs the reconfiguration failure procedure.
6. Upon successful completion of the reconfiguration, the success of the procedure is indicated in the SgNB Modification Confirm message containing the encoded NR RRC response message, if received from the UE.
7. If instructed, the UE performs synchronisation towards the PSCell of the SN as described in SN addition procedure. Otherwise, the UE may perform UL transmission after having applied the new configuration.
8. If PDCP termination point is changed for bearers using RLC AM, and when RRC full configuration is not used, the SN Status Transfer takes place between the MN and the SN (FIG. 5 depicts the case where a bearer context is transferred from the SN to the MN).
NOTE 2a: The SN may not be aware that a SN terminated bearer requesting to release is reconfigured to a MN terminated bearer. The SN Status for the released SN terminated bearers with RLC AM may also be transferred to the MN.
9. If applicable, data forwarding between MN and the SN takes place (FIG. 5 depicts the case where a bearer context is transferred from the SN to the MN).
10. The SN sends the Secondary RAT Data Usage Report message to the MN and includes the data volumes delivered to and received from the UE over the NR radio for the E-RABs to be released.
NOTE 3: The order the SN sends the Secondary RAT Data Usage Report message and performs data forwarding with MN is not defined. The SN may send the report when the transmission of the related bearer is stopped.
11. If applicable, a path update is performed.
   SN Initiated SN Modification without MN Involvement

The SN initiated modification without MN involved procedure is used to modify the configuration within SN in case no coordination with MN is required, including the addition/modification/release of SCG SCell and PSCell change (e.g. when the security key does not need to be changed and the MN does not need to be involved in PDCP recovery). The SN may initiate the procedure to configure or modify CPC configuration within the same SN. FIG. 6 (i.e., FIG. 10.3.1-3 in Section 10.3.1) shows an example signalling flow for SN initiated SN modification procedure, without MN involvement. The SN can decide whether the Random Access procedure is required.
1. The SN sends the RRCReconfiguration message to the UE through SRB3. The UE applies the new configuration. In case the UE is unable to comply with (part of) the configuration included in the RRCReconfiguration message, it performs the reconfiguration failure procedure.
2. If instructed, the UE performs synchronisation towards the PSCell of the SN.
3. The UE replies with the RRCReconfigurationComplete message.
   SN Initiated Conditional SN Modification (CPC) without MN Involvement (SRB3 is Used)

The SN initiates the procedure when it needs to transfer an NR RRC message to the UE and SRB3 is used to configure CPC. FIG. 7 (i.e., FIG. 10.3.1-3a in Section 10.3.1) shows an example signalling flow for SN initiated SN Modification without MN involvement and with SRB3 being used to configure CPC.
1. The SN sends the RRCReconfiguration message including CPC configuration to the UE through SRB3.
2. The UE applies the new configuration. The UE starts evaluating the CPC execution conditions for the candidate PSCell(s). The UE maintains connection with the source PSCell and replies with the RRCReconfigurationComplete message to the SN via SRB3.
3. If at least one CPC candidate PSCell satisfies the corresponding CPC execution condition, the UE detaches from the source PSCell, applies the stored configuration corresponding to the selected candidate PSCell and synchronises to the candidate PSCell.
4. The UE completes the CPC execution procedure by sending an RRCReconfigurationComplete message to the new PSCell.
   Transfer of an NR RRC Message to/from the UE (when SRB3 is not Used)

The SN initiates the procedure when it needs to transfer an NR RRC message to the UE and SRB3 is not used. FIG. 8 (i.e., FIG. 10.3.1-4 in Section 10.3.1) shows an example signalling flow for transfer of an NR RRC message to/from the UE when SRB3 is not used.
1. The SN initiates the procedure by sending the SgNB Modification Required to the MN.
2. The MN forwards the NR RRC message to the UE in the RRCConnectionReconfiguration message.
3. The UE applies the new configuration and replies with the RRCConnectionReconfigurationComplete message.
4. The MN forwards the NR RRC response message, if received from the UE, to the SN in the SgNB Modification Confirm message.
5. If instructed, the UE performs synchronisation towards the PSCell of the SN as described in SgNB Addition procedure. Otherwise the UE may perform UL transmission after having applied the new configuration.
   SN Initiated Conditional SN Modification (CPC) without MN Involvement (SRB3 is not Used)

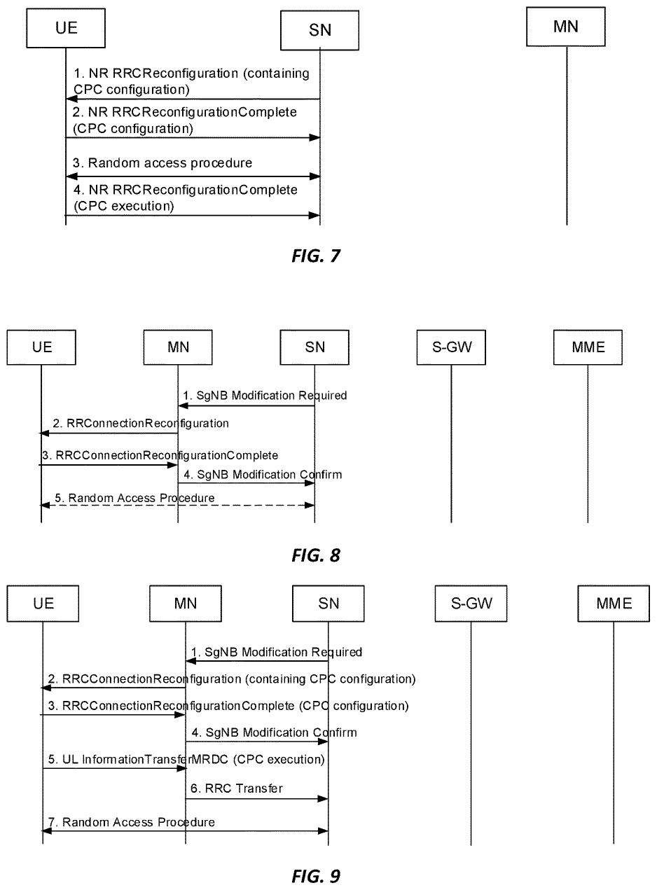

The SN initiates the procedure when it needs to transfer an NR RRC message to the UE and SRB3 is not used to configure CPC. FIG. 9 (i.e., FIG. 10.3.1-5 in Section 10.3.1) shows an example signalling flow for SN initiated SN Modification procedure without MN involvement and without SRB3 being used to configure CPC.
1. The SN initiates the procedure by sending the SgNB Modification Required to the MN including the SN RRC reconfiguration message with CPC configuration.
2. The MN forwards the SN RRC reconfiguration message to the UE including it in the RRCConnectionReconfiguration message.
3. The UE replies with the RRCConnectionReconfigurationComplete message by including the SN RRC reconfiguration complete message. The UE maintains connection with source PSCell after receiving CPC configuration, and starts evaluating the CPC execution conditions for the candidate PSCell(s).
4. The MN forwards the SN RRC response message, if received from the UE, to the SN by including it in the SgNB Modification Confirm message.
5. If at least one CPC candidate PSCell satisfies the corresponding CPC execution condition, the UE completes the CPC execution procedure by an ULInformationTransferMRDC message to the MN which includes an embedded RRCReconfigurationComplete message to the selected target PSCell.
6. The RRCReconfigurationComplete is forwarded to the SN embedded in RRC Transfer.
7. The UE detaches from the source PSCell, applies the stored corresponding configuration and synchronises to the selected candidate PSCell.
   10.3.2 MR-DC with 5GC

The SN Modification procedure may be initiated either by the MN or by the SN and be used to modify the current user plane resource configuration (e.g. related to PDU session, QoS flow or DRB) or to modify other properties of the UE context within the same SN. It may also be used to transfer an RRC message from the SN to the UE via the MN and the response from the UE via MN to the SN (e.g. when SRB3 is not used). In NGEN-DC (NG-RAN E-UTRA-NR Dual Connectivity) and NR-DC, the RRC message is an NR message (i.e., RRCReconfiguration) whereas in NE-DC it is an E-UTRA message (i.e., RRCConnectionReconfiguration). In case of CPC, this procedure is used to configure or modify CPC configuration within the same SN. The CPC configuration cannot be used to configure target PSCell in NE-DC or in NGEN-DC.

The SN modification procedure does not necessarily need to involve signalling towards the UE.

### MN Initiated SN Modification

The MN uses the procedure to initiate configuration changes of the SCG within the same SN, including addition, modification or release of the user plane resource configuration. The MN uses this procedure to perform handover within the same MN while keeping the SN, when the SN needs to be involved (i.e. in NGEN-DC). The MN also uses the procedure to query the current SCG configuration, e.g. when delta configuration is applied in an MN initiated SN change. The MN also uses the procedure to provide the S-RLF related information to the SN or to provide additional available DRB IDs to be used for SN terminated bearers. The MN may not use the procedure to initiate the addition, modification or release of SCG SCells. The SN may reject the request, except if it concerns the release of the user plane resource configuration, or if it is used to perform handover within the same MN while keeping the SN. FIG. 10 (i.e., FIG. 10.3.2-1 in Section 10.3.2) shows an example signalling flow for an MN initiated SN Modification procedure.
1. The MN sends the SN Modification Request message, which may contain user plane resource configuration related or other UE context related information, PDU session level Network Slice info and the requested SCG configuration information, including the UE capabilities coordination result to be used as basis for the reconfiguration by the SN. In case a security key update in the SN is required, a new SN Security Key is included. In case the PDCP data recovery in the SN is required, the PDCP Change Indication is included which indicates that PDCP data recovery is required in SN.
2. The SN responds with the SN Modification Request Acknowledge message, which may contain new SCG radio configuration information within an SN RRC reconfiguration message, and data forwarding address information (if applicable).
NOTE 1: For MN terminated bearers to be setup for which PDCP duplication with CA is configured in NR SCG side, the MN allocates up to 4 separate Xn-U bearers and the SN provides a logical channel ID for primary or split secondary path to the MN.
   For SN terminated bearers to be setup for which PDCP duplication with CA is configured in NR MCG side, the SN allocates up to 4 separate Xn-U bearers and the MN provides a logical channel ID for primary or split secondary path to the SN via an additional MN-initiated SN modification procedure.
2a. When applicable, the MN provides data forwarding address information to the SN. For SN terminated bearers using MCG resources, the MN provides Xn-U DL TNL address information in the Xn-U Address Indication message.
3/4. The MN initiates the RRC reconfiguration procedure, including an SN RRC reconfiguration message. The UE applies the new configuration, synchronizes to the MN (if instructed, in case of intra-MN handover) and replies with MN RRC reconfiguration complete message, including an SN RRC response message, if needed. In case the UE is unable to comply with (part of) the configuration included in the MN RRC reconfiguration message, it performs the reconfiguration failure procedure.
5. Upon successful completion of the reconfiguration, the success of the procedure is indicated in the SN Reconfiguration Complete message.
6. If instructed, the UE performs synchronisation towards the PSCell of the SN as described in SN addition procedure. Otherwise, the UE may perform UL transmission after having applied the new configuration.
7. If PDCP termination point is changed for bearers using RLC AM, and when RRC full configuration is not used, the SN Status Transfer takes place between the MN and the SN (FIG. 10.3.2-1 depicts the case where a bearer context is transferred from the MN to the SN).
8. If applicable, data forwarding between MN and the SN takes place (FIG. 10 depicts the case where a user plane resource configuration related context is transferred from the MN to the SN).
9. The SN sends the Secondary RAT Data Usage Report message to the MN and includes the data volumes delivered to and received from the UE as described in clause 10.11.2.
NOTE 2: The order the SN sends the Secondary RAT Data Usage Report message and performs data forwarding with MN is not defined. The SN may send the report when the transmission of the related QoS flow is stopped.
10. If applicable, a PDU Session path update procedure is performed.
   SN Initiated SN Modification with MN Involvement

The SN uses the procedure to perform configuration changes of the SCG within the same SN, e.g. to trigger the modification/release of the user plane resource configuration, to trigger the release of SCG resources (e.g., release SCG lower layer resources but keep SN), and to trigger PSCell changes (e.g. when a new security key is required or when the MN needs to perform PDCP data recovery). The MN cannot reject the release request of PDU session/QoS flows and the release request of SCG resources. The SN also uses the procedure to request the MN to provide more DRB IDs to be used for SN terminated bearers or to return DRB IDs used for SN terminated bearers that are not needed any longer. FIG. 11 (i.e., FIG. 10.3.2-2 in Section 10.3.2) shows an example signalling flow for SN initiated SN Modification procedure.
1. The SN sends the SN Modification Required message including an SN RRC reconfiguration message, which may contain user plane resource configuration related context, other UE context related information and the new radio resource configuration of SCG. In case of change of security key, the PDCP Change Indication indicates that an SN security key update is required. In case the MN needs to perform PDCP data recovery, the PDCP Change Indication indicates that PDCP data recovery is required.

The SN can decide whether the change of security key is required.
2/3. The MN initiated SN Modification procedure may be triggered by SN Modification Required message, e.g. when an SN security key change needs to be applied.
NOTE 3: For SN terminated bearers to be setup for which PDCP duplication with CA is configured in NR MCG side, the SN allocates up to 4 separate Xn-U bearers and the MN provides a logical channel ID for primary or split secondary path to the SN via the nested MN-initiated SN modification procedure.
4. The MN sends the MN RRC reconfiguration message to the UE including the SN RRC reconfiguration message with the new SCG radio resource configuration.
5. The UE applies the new configuration and sends the MN RRC reconfiguration complete message, including an SN RRC response message, if needed. In case the UE is unable to comply with (part of) the configuration included in the MN RRC reconfiguration message, it performs the reconfiguration failure procedure.
6. Upon successful completion of the reconfiguration, the success of the procedure is indicated in the SN Modification Confirm message including the SN RRC response message, if received from the UE.
7. If instructed, the UE performs synchronisation towards the PSCell configured by the SN as described in SN Addition procedure. Otherwise, the UE may perform UL transmission directly after having applied the new configuration.
8. If PDCP termination point is changed for bearers using RLC AM, and when RRC full configuration is not used, the SN Status Transfer takes place between the MN and the SN (FIG. 10.3.2-2 depicts the case where a bearer context is transferred from the SN to the MN).
9. If applicable, data forwarding between MN and the SN takes place (FIG. 11 depicts the case where a user plane resource configuration related context is transferred from the SN to the MN).
10. The SN sends the Secondary RAT Data Usage Report message to the MN and includes the data volumes delivered to and received from the UE as described in clause 10.11.2.
NOTE 4: The order the SN sends the Secondary RAT Data Usage Report message and performs data forwarding with MN is not defined. The SN may send the report when the transmission of the related QoS flow is stopped.
11. If applicable, a PDU Session path update procedure is performed.
   SN Initiated SN Modification without MN Involvement

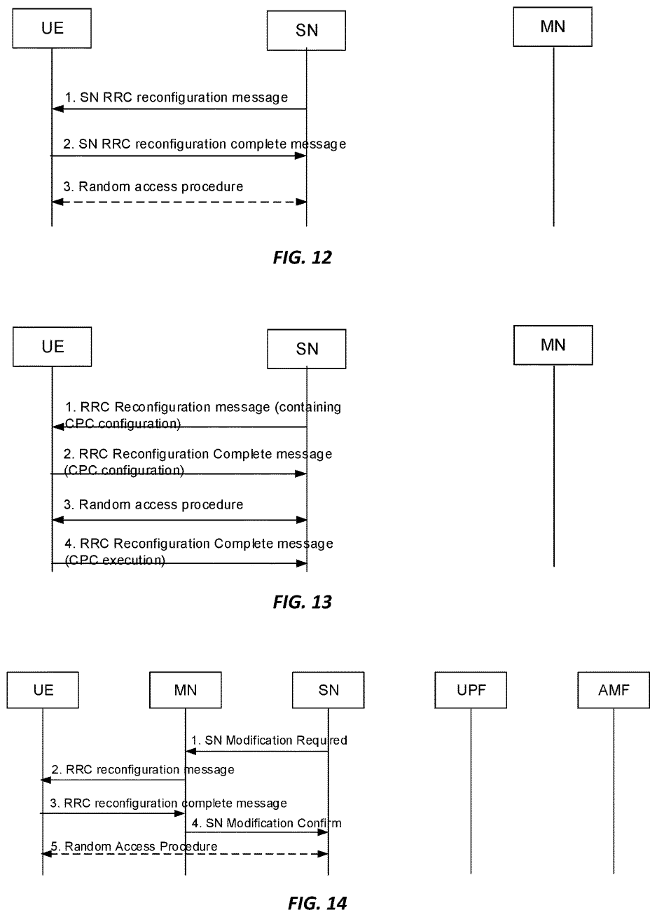

This procedure is not supported for NE-DC. The SN initiated SN modification procedure without MN involvement is used to modify the configuration within SN in case no coordination with MN is required, including the addition/modification/release of SCG SCell and PSCell change (e.g. when the security key does not need to be changed and the MN does not need to be involved in PDCP recovery). The SN may initiate the procedure to configure or modify CPC configuration within the same SN. FIG. 12 (i.e., FIG. 10.3.2-3 in Section 10.3.2) shows an example signalling flow for an SN initiated SN modification procedure without MN involvement. The SN can decide whether the Random Access procedure is required.
1. The SN sends the SN RRC reconfiguration message to the UE through SRB3.
2. The UE applies the new configuration and replies with the SN RRC reconfiguration complete message. In case the UE is unable to comply with (part of) the configuration included in the SN RRC reconfiguration message, it performs the reconfiguration failure procedure.
3. If instructed, the UE performs synchronisation towards the PSCell of the SN as described in SN Addition procedure. Otherwise the UE may perform UL transmission after having applied the new configuration.
   SN Initiated Conditional SN Modification (CPC) without MN Involvement (SRB3 is Used)

This procedure is not supported for NE-DC and NGEN-DC. The SN initiates the procedure when it needs to transfer an NR RRC message to the UE and SRB3 is used to configure CPC. FIG. 13 (i.e., FIG. 10.3.2-3a in Section 10.3.2) shows an example signalling flow for an SN initiated SN Modification without MN involvement and SRB3 is used to configure CPC.
1. The SN sends the SN RRC reconfiguration including CPC configuration to the UE through SRB3.
2. The UE applies the new configuration. The UE starts evaluating the CPC execution conditions for the candidate PSCell(s). The UE maintains connection with the source PSCell and replies with the RRCReconfigurationComplete message to the SN via SRB3.
3. If at least one CPC candidate PSCell satisfies the corresponding CPC execution condition, the UE detaches from the source PSCell, applies the stored configuration corresponding to the selected candidate PSCell and synchronises to the candidate PSCell.
4. The UE completes the CPC execution procedure by sending an RRCReconfigurationComplete message to the new PSCell.
   Transfer of an NR RRC Message to/from the UE (when SRB3 is not Used)

This procedure is supported for all the MR-DC options. The SN initiates the procedure when it needs to transfer an NR RRC message to the UE and SRB3 is not used. FIG. 14 (i.e., FIG. 10.3.2-4 in Section 10.3.2) shows an example signalling flow for transfer of an NR RRC message to/from the UE.
1. The SN initiates the procedure by sending the SN Modification Required to the MN including the SN RRC reconfiguration message.
2. The MN forwards the SN RRC reconfiguration message to the UE including it in the RRC reconfiguration message.
3. The UE applies the new configuration and replies with the RRC reconfiguration complete message by including the SN RRC reconfiguration complete message.
4. The MN forwards the SN RRC response message, if received from the UE, to the SN by including it in the SN Modification Confirm message.
5. If instructed, the UE performs synchronisation towards the PSCell of the SN as described in SN Addition procedure. Otherwise the UE may perform UL transmission after having applied the new configuration.
   SN Initiated Conditional SN Modification (CPC) without MN Involvement (SRB3 is not Used)

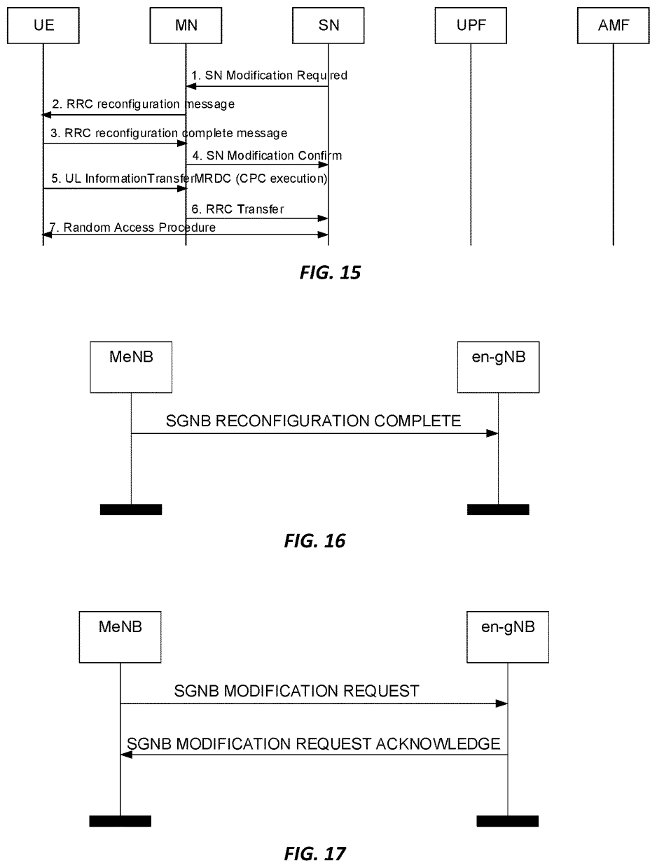

This procedure is not supported for NE-DC and NGEN-DC. The SN initiates the procedure when it needs to transfer an NR RRC message to the UE and SRB3 is not used to configure CPC. FIG. 15 (i.e., FIG. 10.3.2-5 in Section 10.3.2) shows an example signalling flow for an SN initiated SN Modification without MN involvement and SRB3 is not used to configure CPC.
1. The SN initiates the procedure by sending the SN Modification Required to the MN including the SN RRC reconfiguration message with CPC configuration.
2. The MN forwards the SN RRC reconfiguration message to the UE including it in the RRCReconfiguration message.
3. The UE replies with the RRCReconfigurationComplete message by including the SN RRC reconfiguration complete message. The UE maintains connection with source PSCell after receiving CPC configuration, and starts evaluating the CPC execution conditions for the candidate PSCell(s).
4. The MN forwards the SN RRC response message, if received from the UE, to the SN by including it in the SN Modification Confirm message.
5. If at least one CPC candidate PSCell satisfies the corresponding CPC execution condition, the UE completes the CPC execution procedure by an ULInformationTransferMRDC message to the MN which includes an embedded RRCReconfigurationComplete message to the selected target PSCell.
6. The RRCReconfigurationComplete is forwarded to the SN embedded in RRC Transfer.
7. The UE detaches from the source PSCell, applies the stored corresponding configuration and synchronises to the selected candidate PSCell.

### MeNB Initiated SgNB Modification Preparation

For the same procedure, MeNB initiated SgNB Modification Preparation, TS 36.423 stage 3 specification describes as follows.

### 8.7.5 SgNB Reconfiguration Completion

### 8.7.5.1 General

The purpose of the SgNB Reconfiguration Completion procedure is to provide information to the en-gNB whether the requested configuration was successfully applied by the UE.

The procedure uses UE-associated signalling.

### 8.7.5.2 Successful Operation

FIG. 16 (i.e., FIG. 8.7.5.2-1 in Section 8.7.5.2) shows a SgNB Reconfiguration Complete procedure with successful operation. The MeNB initiates the procedure by sending the SGNB RECONFIGURATION COMPLETE message to the en-gNB. The SGNB RECONFIGURATION COMPLETE message may contain information that
either the UE has successfully applied the configuration requested by the en-gNB. The MeNB may also provide NR RRCReconfigurationComplete message in the MeNB to SgNB Container IE.
or the configuration requested by the en-gNB has been rejected. The MeNB shall provide information with sufficient precision in the included Cause IE to enable the en-gNB to know the reason for an unsuccessful reconfiguration.

Upon reception of the SGNB RECONFIGURATION COMPLETE message the en-gNB shall stop the timer T_{DCoverall}.

### 8.7.5.3 Abnormal Conditions

Void.

### 8.7.6 MeNB Initiated SgNB Modification Preparation

### 8.7.6.1 General

This procedure is used to enable an MeNB to request an en-gNB to modify the UE context at the en-gNB, or to query the current SCG configuration for supporting delta signalling in MeNB initiated SgNB change, or to provide the S-RLF-related information to the en-gNB.

The procedure uses UE-associated signalling.

### 8.7.6.2 Successful Operation

FIG. 17 (i.e., FIG. 8.7.6.2-1 in Section 8.7.6.2) shows a MeNB initiated SgNB Modification Preparation with successful operation. The MeNB initiates the procedure by sending the SGNB MODIFICATION REQUEST message to the en-gNB. When the MeNB sends the SGNB MODIFICATION REQUEST message, it shall start the timer T_{DCprep}. The SGNB MODIFICATION REQUEST message may contain:
within the UE Context Information IE (if the modification of the UE context at the en-gNB is requested);
   E-RABs to be added within the E-RABs To Be Added Item IE;
   E-RABs to be modified within the E-RABs To Be Modified Item IE;
   E-RABs to be released within the E-RABs To Be Released Item IE;
   the SgNB UE Aggregate Maximum Bit Rate IE;
the MeNB to SgNB Container IE;
the SCG Configuration Query IE;
the MeNB Resource Coordination Information IE;
the Requested split SRBs IE;
the Requested split SRBs release IE;
the Requested fast MCG recovery via SRB3 IE;
the Requested fast MCG recovery via SRB3 Release IE.

If the SGNB MODIFICATION REQUEST message contains the Serving PLMN IE, the en-gNB may use it for RRM purposes.

If the SGNB MODIFICATION REQUEST message contains the Handover Restriction List IE, the en-gNB shall
replace the previously provided Handover Restriction List by the received Handover Restriction List in the UE context;
use this information to select an appropriate NR cell.

If the SgNB UE Aggregate Maximum Bit Rate IE is included in the SGNB MODIFICATION REQUEST message, the en-gNB shall:
replace the previously provided SgNB UE Aggregate Maximum Bit Rate by the received SgNB UE Aggregate Maximum Bit Rate in the UE context;
use the received SgNB UE Aggregate Maximum Bit Rate for non-GBR Bearers for the concerned UE as defined in TS 37.340.

The allocation of resources according to the values of the QCI IE, Allocation and Retention Priority IE or GBR QoS Information IE included in the Full E-RAB Level QoS Parameters IE or in the Requested SCG E-RAB Level QoS Parameters IE shall follow the principles described for the E-RAB Setup procedure in TS 36.413.

If the SGNB MODIFICATION REQUEST message contains the MeNB Resource Coordination Information IE, the en-gNB should forward it to lower layers and it may use it for the purpose of resource coordination with the MeNB, or to coordinate with sidelink resources used in the MeNB. The en-gNB shall consider the received UL Coordination Information IE value valid until reception of a new update of the IE for the same UE. The en-gNB shall consider the received DL Coordination Information IE value valid until reception of a new update of the IE for the same UE. If the MeNB Coordination Assistance Information IE is contained in the MeNB Resource Coordination Information IE, the en-gNB shall, if supported, use the information to determine further coordination of resource utilisation between the en-gNB and the MeNB.

If at least one of the requested modifications is admitted by the en-gNB, the en-gNB shall modify the related part of the UE context accordingly and send the SGNB MODIFICATION REQUEST ACKNOWLEDGE message back to the MeNB.

The en-gNB shall include the E-RABs for which resources have been either added or modified or released at the en-gNB either in the E-RABs Admitted To Be Added List IE or the E-RABs Admitted To Be Modified List IE or the E-RABs Admitted To Be Released List IE. The en-gNB shall include the E-RABs that have not been admitted in the E-RABs Not Admitted List IE with an appropriate cause value.

For each E-RAB successfully established or modified or released in the en-gNB, the en-gNB shall report to the MeNB, in the SGNB MODIFICATION REQUEST ACKNOWLEDGE message, the same value in the EN-DC Resource Configuration IE as received in the SGNB MODIFICATION REQUEST message.

The en-gNB shall, if included, choose the ciphering algorithm based on the information in the NR UE Security Capabilities IE and locally configured priority list of AS encryption algorithms and apply the key indicated in the SgNB Security Key IE as specified in the TS 33.401.

For each E-RAB for which allocation of the PDCP entity is requested at the en-gNB:
if applicable, the MeNB may propose to apply forwarding of downlink data by including the DL Forwarding IE within the E-RABs To Be Added Item IE of the SGNB MODIFICATION REQUEST message. For each E-RAB that it has decided to admit, the en-gNB may include the DL Forwarding GTP Tunnel Endpoint IE within the E-RABs Admitted To Be Added Item IE of the SGNB MODIFICATION REQUEST ACKNOWLEDGE message to indicate that it accepts the proposed forwarding of downlink data for this bearer. The MeNB may also provide for an applicable E-RAB to be released the DL Forwarding GTP Tunnel Endpoint IE and the UL Forwarding GTP Tunnel Endpoint IE within the E-RABs To Be Released Item IE of the SGNB MODIFICATION REQUEST message.
if applicable, the en-gNB may include for each bearer in the E-RABs Admitted To Be Added List IE in the SGNB MODIFICATION REQUEST ACKNOWLEDGE message the UL Forwarding GTP Tunnel Endpoint IE to indicate that it requests data forwarding of uplink packets to be performed for that bearer.
if applicable, the en-gNB may include for each bearer in the E-RABs Admitted To Be Modified List IE which is configured with the SN terminated split bearer option in the SGNB MODIFICATION REQUEST ACKNOWLEDGE message the UL Configuration IE to indicate that the MCG UL configuration of the UE has changed.
if applicable, the en-gNB may include for each bearer in the E-RABs Admitted To Be Added List IE in the SGNB MODIFICATION REQUEST ACKNOWLEDGE message the UL PDCP SN Length IE and the DL PDCP SN Length IE to indicate the PDCP SN length for that bearer.
If the Bearer Type IE for the concerned E-RAB is received by the en-gNB and is set to “non IP”, then the en-gNB shall, if supported, not perform IP header compression for the concerned E-RAB.
If the Ethernet Type IE for the concerned E-RAB is received by the en-gNB and is set to “True”, the en-gNB shall take this into account to perform header compression appropriately for the concerned E-RAB.

For each E-RAB configured with SCG resources and the PDCP entity is hosted by the MeNB and
requested to be modified,
   if the SGNB MODIFICATION REQUEST message includes the MeNB UL GTP Tunnel Endpoint at PDCP IE in the E-RABs To Be Modified Item IE, the en-gNB shall act as specified in TS 37.340.
   if the SGNB MODIFICATION REQUEST message contains the MeNB UL GTP Tunnel Endpoint at PDCP IE the en-gNB shall use it as the new UL X2-U address.
   the en-gNB may include in the SGNB MODIFICATION REQUEST ACKNOWLEDGE message the SgNB DL GTP Tunnel Endpoint at SCG IE.

If, dependent on the configured bearer type, the Full E-RAB Level QoS Parameters IE or the Maximum MCG admittable E-RAB Level QoS Parameters IE or the Requested SCG E-RAB level QoS Parameters IE are included in the SGNB MODIFICATION REQUEST message for an E-RAB to be modified the en-gNB shall allocate respective resources and provide corresponding radio configuration information within the SgNB to MeNB Container IE as described in TS 37.340.

If the SGNB MODIFICATION REQUEST message contains, for an E-RAB to be modified which is configured with the PDCP entity in the en-gNB, the S1 UL GTP Tunnel Endpoint IE, the en-gNB shall use it as the new UL S1-U address.

If the SGNB MODIFICATION REQUEST message contains an E-RAB to be modified which is configured with the MN terminated split bearer option, the MeNB may include the UL Configuration IE to indicate that the SCG UL configuration of the UE has changed.

If the SGNB MODIFICATION REQUEST message contains for an E-RAB to be modified which is configured with the PDCP enitiy in the en-gNB and MCG resources the MeNB DL GTP Tunnel Endpoint at MCG IE the en-gNB shall use it as the DL X2-U address.

If the SGNB MODIFICATION REQUEST message contains the Subscriber Profile ID for RAT/Frequency Priority IE, the en-gNB may use it for RRM purposes.

If the SGNB MODIFICATION REQUEST message contains the Additional RRM Policy Index IE, the en-gNB may use it for RRM purposes.

For an E-RAB to be modified which is configured with the PDCP entity in the en-gNB the en-gNB may include in the SGNB MODIFICATION REQUEST ACKNOWLEDGE message the S1 DL GTP Tunnel Endpoint at the SgNB IE.

If the SGNB MODIFICATION REQUEST ACKNOWLEDGE message contains the SgNB Resource Coordination Information IE, the MeNB may use it for the purpose of resource coordination with the en-gNB. The MeNB shall consider the received UL Coordination Information IE value valid until reception of a new update of the IE for the same UE. The MeNB shall consider the received DL Coordination Information IE value valid until reception of a new update of the IE for the same UE. If the SgNB Coordination Assistance Information IE is contained in the SgNB Resource Coordination Information IE, the MeNB shall, if supported, use the information to determine further coordination of resource utilisation between the en-gNB and the MeNB.

Upon reception of the SGNB MODIFICATION REQUEST ACKNOWLEDGE message the MeNB shall stop the timer T_{DCprep}. If the SGNB MODIFICATION REQUEST ACKNOWLEDGE message has included the SgNB to MeNB Container IE the MeNB is then defined to have a Prepared SgNB Modification for that X2 UE-associated signalling.

If the SCG Configuration Query IE is included in the SGNB MODIFICATION REQUEST message, the en-gNB shall provide corresponding radio configuration information within the SgNB to MeNB Container IE as described in TS 37.340.

If the SGNB MODIFICATION REQUEST message contains the Requested split SRBs IE, the en-gNB may use it to add split SRBs. If the SGNB MODIFICATION REQUEST message contains the Requested split SRBs release IE, the en-gNB may use it to release split SRBs.

If the Requested Fast MCG recovery via SRB3 IE set to “true” is included in the SGNB MODIFICATION REQUEST message and the en-gNB decides to configure fast MCG link recovery via SRB3 as specified in TS 37.340, the en-gNB shall, if supported, include the Available fast MCG recovery via SRB3 IE set to “true” in the SGNB MODIFICATION REQUEST ACKNOWLEDGE message. If the Requested Fast MCG recovery via SRB3 Release IE set to “true” is included in the SGNB MODIFICATION REQUEST message and the en-gNB decides to release fast MCG link recovery via SRB3, the en-gNB shall, if supported, include the Release fast MCG recovery via SRB3 IE set to “true” in the SGNB MODIFICATION REQUEST ACKNOWLEDGE message.

If the en-gNB receives for an E-RAB to be setup for which the PDCP entiy is allocated at the MeNB the Secondary MeNB UL GTP Tunnel Endpoint at PDCP IE and the Duplication Activation IE in the SGNB MODIFICATION REQUEST message, it may provide the Secondary SgNB DL GTP Tunnel Endpoint at SCG IE and the LCID IE to the MeNB in the SGNB MODIFICATION REQUEST ACKNOWLEDGE message if PDCP duplication is configured at the en-gNB.

If the SGNB MODIFICATION REQUEST message contains the RLC Status IE, the en-gNB shall assume that RLC has been reestablished at the MeNB and may trigger PDCP data recovery.

If the en-gNB applied a full configuration or delta configuration, e.g. as part of a mobility procedure involving a change of DU, the en-gNB shall inform the MeNB by including the RRC config indication IE in the SGNB MODIFICATION REQUEST ACKNOWLEDGE message.

If SGNB MODIFICATION REQUEST message contains the UL PDCP SN Length IE and the DL PDCP SN Length IE, the en-gNB shall, if supported, store this information and use it for lower layer configuration of the concerned MN terminated bearer.

If the RLC Mode IE is included for an E-RAB within the E-RABs To be Added List IE in the SGNB MODIFICATION REQUEST message, it indicates the mode that the MeNB used for the E-RAB when it was hosted at the MeNB.

If the SGNB MODIFICATION REQUEST message contains the MeNB Cell ID IE, the en-gNB may search for the target NR cell among the NR neighbour cells of the E-UTRAN cell indicated in MeNB Cell ID IE, as specified in the TS 37.340.

If the SGNB MODIFICATION REQUEST ACKNOWLEDGE message contains the RLC Status IE, the MeNB shall assume that RLC has been reestablished at the en-gNB and may trigger PDCP data recovery.

The en-gNB may include the Location Information at SgNB IE in the SGNB MODIFICATION REQUEST ACKNOWLEDGE message, if respective information is available at the en-gNB.

If the Location Information at en-gNB Reporting IE set to “pscell” is included in the SGNB MODIFICATION REQUEST, the SgNB shall start providing information about the current location of the UE. If the Location Information at SgNB IE is included in the SGNB MODIFICATION REQUEST ACKNOWLEDGE, the MeNB shall store the included information so that it may be transferred towards the MME.

If the Lower Layer presence status change IE set to “release lower layers” is included in the SGNB MODIFICATION REQUEST message, the en-gNB shall act as specified in TS 37.340.

If the Lower Layer presence status change IE set to “re-establish lower layers” is included in the SGNB MODIFICATION REQUEST message, the en-gNB shall act as specified in TS 37.340.

If the Lower Layer presence status change IE set to “suspend lower layers” is included in the SGNB MODIFICATION REQUEST message, the en-gNB shall act as specified in TS 37.340.

If the Lower Layer presence status change IE set to “resume lower layers” is included in the SGNB MODIFICATION REQUEST message, the en-gNB shall act as specified in TS 37.340.

If the SGNB MODIFICATION REQUEST message contains the LAB Node Indication IE, the en-gNB shall, if supported, consider that the request is for an IAB node.

For each requested E-RAB configured as MN-terminated split bearer/SCG bearer, if the QoS Mapping Information IE is contained in the GTP Tunnel Endpoint IE in the SGNB MODIFICATION REQUEST ACKNOWLEDGE message, the MeNB shall, if supported, use it to set DSCP and/or flow label fields for the downlink IP packets which are transmitted from MeNB to SgNB through the GTP tunnels indicated by the GTP Tunnel Endpoint IE.

Interactions with the MeNB Initiated SgNB Modification Procedure:

If the en-gNB provides for an E-RAB to be setup for which the PDCP entiy is allocated at the MeNB the Secondary SgNB DL GTP Tunnel Endpoint at SCG IE and the LCID IE to the MeNB in the SGNB MODIFICATION REQUEST ACKNOWLEDGE message and the MeNB has not provided the Secondary MeNB UL GTP Tunnel Endpoint at PDCP IE and the Duplication Activation IE in the SGNB MODIFICATION REQUEST message, the MeNB shall trigger the MeNB initiated SgNB Modification procedure to provide the Secondary MeNB UL GTP Tunnel Endpoint at PDCP IE and the Duplication Activation IE to the SgNB.

Interactions with the SgNB Reconfiguration Completion Procedure:

If the en-gNB admits a modification of the UE context requiring the MeNB to report about the success of the RRC connection reconfiguration procedure, the en-gNB shall start the timer T_{DCoverall} when sending the SGNB MODIFICATION REQUEST ACKNOWLEDGE message to the MeNB. The reception of the SGNB RECONFIGURATION COMPLETE message shall stop the timer T_{DCoverall}.

Interaction with the Activity Notification Procedure

Upon receiving an SGNB MODIFICATION REQUEST message containing the Desired Activity Notification Level IE, the en-gNB shall, if supported, use this information to decide whether to trigger subsequent SgNB Activity Notification procedures, or stop or modify ongoing triggering of these procedures due to a previous request.

Interaction with the SgNB Initiated SgNB Modification Preparation Procedure:

If the MeNB receives the SGNB MODIFICATION REQUIRED message and the requested SN modification procedure needs further information from MeNB, the MeNB shall send SGNB MODIFICATION REQUEST message to en-gNB in response to a previously SgNB initiated SgNB Modification procedure.

### 8.7.6.3 Unsuccessful Operation

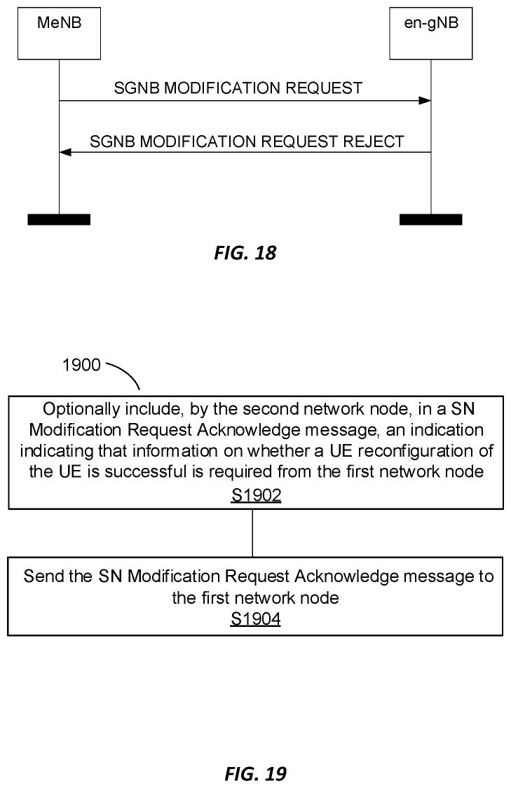

FIG. 18 (i.e., FIG. 8.7.6.3-1 in Section 8.7.6.3) shows a MeNB initiated SgNB Modification Preparation with unsuccessful operation.

If the en-gNB does not admit any modification requested by the MeNB, or a failure occurs during the MeNB initiated SgNB Modfication Preparation, the en-gNB shall send the SGNB MODIFICATION REQUEST REJECT message to the MeNB. The message shall contain the Cause IE with an appropriate value.

If the en-gNB receives a SGNB MODIFICATION REQUEST message containing the MeNB to SgNB Container IE that does not include required information as specified in TS 38.331, the en-gNB shall send the SGNB MODIFICATION REQUEST REJECT message to the MeNB.

### 8.7.6.4 Abnormal Conditions

If the en-gNB receives a SGNB MODIFICATION REQUEST message containing multiple E-RAB ID IEs (in the E-RABs To Be Added List IE and/or the E-RABs To Be Modified List IE) set to the same value, the en-gNB shall not admit the action requested for the corresponding E-RABs.

If the en-gNB receives an SGNB MODIFICATION REQUEST message containing multiple E-RAB ID IEs (in the E-RAB To Be Released List IE) set to the same value, the en-gNB shall initiate the release of one corresponding E-RAB and ignore the duplication of the instances of the selected corresponding E-RABs.

If the en-gNB receives a SGNB MODIFICATION REQUEST message containing, dependent on the configured bearer type, the Full E-RAB Level QoS Parameters IE or the Requested SCG E-RAB Level QoS Parameters IE which contains a QCI IE indicating a GBR bearer (as defined in TS 23.203), and which does not contain the GBR QoS Information IE, the en-gNB shall not admit the corresponding E-RAB.

If the supported algorithms for encryption defined in the NR Encryption Algorithms IE in the NR UE Security Capabilities IE in the UE Context Information IE, plus the mandated support of NEA0 in all UEs (TS 33.401), do not match any algorithms defined in the configured list of allowed encryption algorithms in the en-gNB (TS 33.401), the en-gNB shall reject the procedure using the SGNB MODIFICATION REQUEST REJECT message.

If the supported algorithms for integrity defined in the NR Integrity Protection Algorithms IE in the NR UE Security Capabilities IE in the UE Context Information IE do not match any algorithms defined in the configured list of allowed integrity protection algorithms in the en-gNB (TS 33.401), the en-gNB shall reject the procedure using the SGNB MODIFICATION REQUEST REJECT message.

If the timer T_{DCprep} expires before the MeNB has received the SGNB MODIFICATION REQUEST ACKNOWLEDGE message, the MeNB shall regard the MeNB initiated SgNB Modification Preparation procedure as being failed and shall release the UE Context at the en-gNB.

If the MeNB has provided the en-gNB for an E-RAB to be setupr which the PDCP entiy is allocated at the MeNB the Secondary MeNB UL GTP Tunnel Endpoint at PDCP IE in the SGNB MODIFICATION REQUEST message, and the en-gNB does not provide the Secondary SgNB DL GTP Tunnel Endpoint at SCG IE to the MeNB in the SGNB MODIFICATION REQUEST ACKNOWLEDGE message, the MeNB shall assume that PDCP duplication was not configured at the en-gNB and releases duplication resources.

If the en-gNB provides for an E-RAB to be setup for which the PDCP entiy is allocated at the MeNB the Secondary SgNB DL GTP Tunnel Endpoint at SCG IE to the MeNB in the SGNB MODIFICATION REQUEST ACKNOWLEDGE message and the MeNB has not provided the Secondary MeNB UL GTP Tunnel Endpoint at PDCP IE in the SGNB MODIFICATION REQUEST message, and the MeNB does not trigger the MeNB initiated SgNB Modification procedure to provide the Secondary MeNB UL GTP Tunnel Endpoint at PDCP IE to the SgNB the en-gNB before the SgNB Reconfigurationi Completion procedure was triggered, the en-gNB shall trigger the release of the concerned E-RAB.

Interactions with the SgNB Reconfiguration Completion and SgNB Initiated SgNB Release Procedure:

If the timer T_{DCoverall} expires before the en-gNB has received the SGNB RECONFIGURATION COMPLETE or the SGNB RELEASE REQUEST message, the en-gNB shall regard the requested modification RRC connection reconfiguration as being not applied by the UE and shall trigger the SgNB initiated SgNB Release procedure.

Interaction with the SgNB Initiated SgNB Modification Preparation Procedure:

If the MeNB, after having initiated the MeNB initiated SgNB Modification procedure, receives the SGNB MODIFICATION REQUIRED message, the MeNB shall refuse the SgNB initiated SgNB Modification procedure with an appropriate cause value in the Cause IE.

If the MeNB has a Prepared SgNB Modification and receives the SGNB MODIFICATION REQUIRED message, the MeNB shall respond with the SGNB MODIFICATION REFUSE message to the en-gNB with an appropriate cause value in the Cause IE.

Interactions with the MeNB Initiated SgNB Release Procedure:

If the timer T_{DCprep} expires before the MeNB has received the SGNB MODIFICATION REQUEST ACKNOWLEDGE message, the MeNB shall regard the SgNB Modification Preparation procedure as being failed and may trigger the MeNB initiated SgNB Release procedure.

Certain challenges currently exist with SN modification procedure in dual connectivity, for example, in the MN initiated SN Modification procedure shown in FIG. 4, it is not clearly stated when or in which case the MeNB (Master eNodeB) should send SgNBReconfigurationComplete message to the SgNB (Secondary gNodeB). For example, when the MeNB wants to configure the LTE measurement gap to give opportunity for inter-frequency or inter-RAT (Radio Access Technology) measurement to the UE configured EN-DC, the MeNB starts with sending X2 SgNBModificationRequest message to SgNB with information specifying the measurement gap configuration and controls setup of measurement gaps. After reception of SgNBModificationRequest message, the SgNB may contain in the SgNBModificationRequestAcknowledge message a configuration that requires synchronization with the UE or just information elements (e.g. PDCP configuration for an SN terminated bearer). In the former case, it may be obvious for MeNB to send SgNBReconfigurationComplete message to SgNB, but in the latter case, it may not be necessary. As the SgNBReconfigurationComplete message may not be sent in time, the MeNB and the SgNB may have different understanding of the UE context, and this may result in unintended operation. For example, each node may perform additional signalling to verify the understanding of each other's UE context, or the UE may receive poor service with lower throughput as EN-DC is release, or the UE may be released in the worst case and no longer be able to receive any service. Further, this kind of mismatched behavior between different vendors' nodes is also very commonly shown when the interpretation of the related technical specifications is different. This is mainly because there is no clear statement of the network's behavior. Such problems need to be addressed.

The present disclosure relates to enhanced SN modification in dual connectivity. For example, the present disclosure provides improved methods, system, devices, and apparatus that support techniques for indicating that the SN is waiting for a response on a modified UE context for an effective MN initiated modification procedure in dual connectivity. It should be understood that although some embodiments are specifically described by referring to TS 36.423, the embodiments can be similarly applied to TS 38.423 as its contents are mostly similar with TS 36.423.

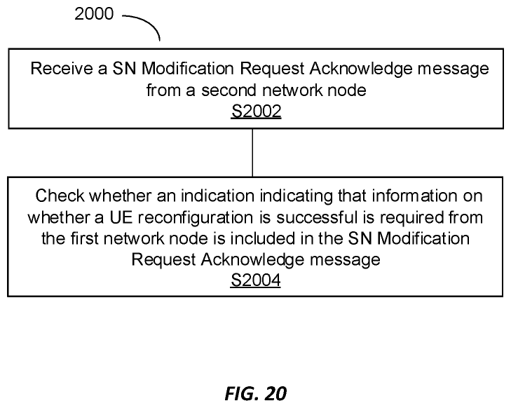

Some embodiments of the present disclosure will be described with reference to FIGS. 19 and 20. FIG. 19 is a flowchart illustrating a method 1900 performed in a network node, and the network node may be implemented with the network node 200 in FIG. 3. Here, the network node may be referred to as “second node” which is a secondary node (SN) communicates with a first network node, i.e., master node (MN) in dual connectivity with the UE. The method may be performed in an MN initiated modification procedure. As shown in FIG. 19, the method 1900 may include: optionally including, by the second network node, in a SN Modification Request Acknowledge message, an indication indicating that information on whether a UE reconfiguration of the UE is successful is required from the first network node (S1902); and sending the SN Modification Request Acknowledge message to the first network node (S1904).

In some embodiments, the method 1900 may further include: receiving, from the first network node, a SN Modification Request message; and determining whether the information is required from the first network node. In one embodiment, the second network node may determine that the information is required if the second network node admits a modification of UE context based on the SN Modification Request message. At S1902, the second network node may include the indication in the SN Modification Request Acknowledge message when it is determined that the information is required, and may not include the indication in the SN Modification Request Acknowledge message when it is determined that the information is not required.

In some embodiments, the method 1900 may further include starting a timer upon sending the SN Modification Request Acknowledge message including the indication to the first network node. In some other embodiments, the method 1900 may further include: upon sending the SN Modification Request Acknowledge message, checking whether the indication is included in the SN Modification Request Acknowledge message; and starting a timer if the indication is included in the SN Modification Request Acknowledge message.

In some embodiments, the method 1900 may further include receiving an SN Reconfiguration Complete message that is sent from the first network node in response to receiving the SN Modification Request Acknowledge message including the indication. The SN Reconfiguration Complete message may be received by the second network node as indicating a success of the UE reconfiguration.

In some embodiments, the method 1900 may further include stopping the timer upon receiving the SN Reconfiguration Complete message from the first network node.

FIG. 20 is a flowchart illustrating a method 2000 performed in a network node, and the network node may be implemented with the network node 200 in FIG. 3. Here, the network node may be referred to as “first node” which is a master node (MN) communicates with a second network node, i.e., secondary node (SN) in dual connectivity with the UE. The method may be performed in an MN initiated modification procedure. As shown in FIG. 20, the method 2000 may include: receiving a SN Modification Request Acknowledge message from a second network node (S2002); and checking whether an indication indicating that information on whether a UE reconfiguration of the UE is successful is required from the first network node is included in the SN Modification Request Acknowledge message (S2004).

In some embodiments, the method 2000 may further comprises initiating, by the first network node, a UE reconfiguration procedure in response to receiving the SN Modification Request Acknowledge message. The first network node may check whether the indication is included in the SN Modification Request Acknowledge message upon a successful completion of the UE reconfiguration. If the indication is included in the SN Modification Request Acknowledge message, the first network node may send an SN Reconfiguration Complete message to the second network node to indicate a success of the UE reconfiguration to the second network node. If the indication is not included, the first network node may not send the SN Reconfiguration Complete message.

In some embodiments, the indication may include an information element in a form of a bit or field in the SN Modification Request Acknowledge message.

In some embodiments, each of the SN Modification Request message, the SN Modification Request Acknowledge message and the SN Reconfiguration Complete message may be a message over X2/Xn interface between the SN and MN configured for dual connectivity.

In some embodiments, each of the first and second network nodes may have its own Radio Resource Control (RRC) entity that can generate RRC Protocol Data Unit (PDU) to be sent to the UE in the dual connectivity.

In some embodiments, each of the first and second network nodes may be deployed in Cloud as virtualized Radio Access Network (RAN) in case of split deployment, or as a network node in site in case of embedded deployment.

In some embodiments, the methods 1900 and 2000 can be performed in Central Unit/Control Plane (CU-CP) with XnAP/X2AP messages conveyed through X2-C/Xn-C interface between Radio Access Networks (RANs) in an Open-RAN (O-RAN) implementation.

More details may be provided by taking the EN-DC scenario as an example. It should be understood that the dual connectivity mode may be any type of MR-DC, such as NGEN-DC, NR-DC, and NE-DC. When the MN (the first network node) determines to reconfigure the UE operating in the dual connectivity mode, the MN may send a SgNBModificationRequest message to modify the UE context at the SN (the second network node), or to query the current SCG configuration for supporting delta signalling in MN initiated SgNB change, or to provide S-RLF-related information to the SN. The SgNBModificationRequest message in X2 interface may also be S-NODE MODIFICATION REQUEST message in Xn interface, or a MN initiated modification request message between the MN and SN configured for dual connectivity.

If at least one of the requested modifications is admitted by the SN, the SN shall modify the related part of the UE context accordingly. Here, if the requested modification does not require any coordination with the SN, the SN may send RRC PDUs directly to the UE via SRB3 if SRB3 exists, or the SN may not modify any UE context. Then, the SN may send a SgNBModificationRequestAcknowledge message to the MN with or without an indication for requesting from the MN information on whether the changed UE context delivered by the SN has been transmitted and applied to the UE. In this step, when the information on whether the changed UE context has been transmitted and applied to the UE is required, the SN may include or set an indication for requesting such information in the SgNBModificationRequestAcknowledge message. When the information is not required, the SN may not include or set the indication in the SgNBModificationRequestAcknowledge message. Here, the SgNBModificationRequestAcknowledge message in X2 interface may also be S-NODE MODIFICATION REQUEST ACKNOWLEDGE in Xn interface, or a modification request acknowledge message between the MN and SN configured for dual connectivity. The indication may be a bit or field indicating that the SN waits for a response from the MN as to know whether the modified UE context is well applied. Even if the SN does not modify the UE context through an ongoing MN initiated modification procedure, the SN may include/set this indication to receive the information from the MN.

Subsequently, the MN may initiate RRC connection reconfiguration procedure to the UE, including an encapsulated NR RRC configuration message (i.e., an SCG configuration) if the SN sends it. Here, the MN may send RRC CONNECTION RECONFIGURATION in LTE, RRC RECONFIGURATION in NR, or any message going to the UE by RRC signaling. This RRC message may include an encapsulated SN RRC reconfiguration message.

With the RRC connection reconfiguration procedure, the UE may apply the new configuration and reply with an RRCConnectionReconfigurationComplete message to the MN. Here, the RRCConnectionReconfigurationComplete message may be RRCReconfigurationComplete message or any message going to the MN by RRC signaling.

Upon successful completion of the UE reconfiguration, the MN may inform the SN of the success of the UE reconfiguration by sending the SgNBReconfigurationComplete message to the SN, if it is requested in the SgNBModificationRequestAcknowledge message. Specifically, the MN may check the presence of the above indication in the SgNBModificationRequestAcknowledge message. If the indication is present (that is, information on the success of the UE reconfiguration is required), the MN may send the SgNBReconfigurationComplete message to the SN. If the indication is not present, the MN may not send the SgNBReconfigurationComplete message.

As above described, an indication indicating that information on whether a UE reconfiguration is successful is required from the MN may be included in SN Modification Request Acknowledge message by the SN. If the SN responds to the MN with SN Modification Request Acknowledge message including such indication, the MN, based on the presence of the indication, should send SN Reconfiguration Complete message to the SN after the reconfiguration procedure to the UE. Otherwise, the MN does not need to send SN Reconfiguration Complete message to the SN. In this way, it is clearly defined when or in which case the MN should send the SN Reconfiguration Complete message to the SN. The MN can clearly know if the SN is waiting for information on whether the UE reconfiguration is successful or not, and it is possible for the MN to send SN Reconfiguration Complete message only if required. As a result, both of the MN and SN can have the same understanding of the UE context, so this can avoid unintended operations (for example, reducing unnecessary message transmission for checking each other's understanding of the UE context via X2 or Xn interface), and guarantee continuity of service to the UE by preventing unintended EN-DC release or UE release.

The indication may be an information element (IE) in a form of a bit or field in the SN Modification Request Acknowledge message. Table 1 shows the functional definition and contents of the SgNBModificationRequestAcknowledge message for X2AP standard (3GPP TS 36.423), with an optional IE “Request Reconfiguration Complete” added at the end of Table 1 to indicate that the SN is waiting for information on whether the UE reconfiguration is successful or not. Note that the IE “Request Reconfiguration Complete” is just an example of the indication, and any other type of information may be used if suitable, and also may be named in any other manner.

TABLE 1

| IE/Group Name | Presence | Range |
|---|---|---|
| Message Type | M | |
| MeNB UE X2AP ID | M | |
| SgNB UE X2AP ID | M | |
| E-RABs Admitted To Be Added List | | 0 . . . 1 |
| >E-RABs Admitted To Be Added Item | | 1 . . . <maxnoofBearers> |
| >>E-RAB ID | M | |
| >>EN-DC Resource Configuration | M | |
| >>CHOICE Resource Configuration | M | |
| >>>PDCP present in SN | | |
| >>>>S1 DL GTP Tunnel Endpoint at the SgNB | M | |
| >>>>SgNB UL GTP Tunnel Endpoint at PDCP | C- | |
| | ifMCGpresent | |
| >>>>RLC Mode | C- | |
| | ifMCGpresent | |
| >>>>DL Forwarding GTP Tunnel Endpoint | O | |
| >>>>UL Forwarding GTP Tunnel Endpoint | O | |
| >>>>Requested MCG E-RAB Level QoS Parameters | C- | |
| | ifMCGandSCGpresent_{—} | |
| | GBRpresent | |
| >>>>UL Configuration | C- | |
| | ifMCGandSCGpresent | |
| >>>>UL PDCP SN Length | O | |
| >>>>DL PDCP SN Length | O | |
| >>>PDCP not present in SN | | |
| >>>>SgNB DL GTP Tunnel Endpoint at SCG | M | |
| >>>>Secondary SgNB DL GTP Tunnel Endpoint at SCG | O | |
| >>>>LCID | O | |
| E-RABs Admitted To Be Modified List | | 0 . . . 1 |
| >E-RABs Admitted To Be Modified Item | | 1 . . . <maxnoofBearers> |
| >>E-RAB ID | M | |
| >>EN-DC Resource Configuration | M | |
| >>CHOICE Resource Configuration | M | |
| >>>PDCP present in SN | | |
| >>>>S1 DL GTP Tunnel Endpoint | O | |
| >>>>SgNB UL GTP Tunnel Endpoint at PDCP | O | |
| >>>>Requested MCG E-RAB Level QoS Parameters | O | |
| >>>>UL Configuration | O | |
| >>>>UL PDCP SN Length | O | |
| >>>>DL PDCP SN Length | O | |
| >>>PDCP not present in SN | | |
| >>>>SgNB DL GTP Tunnel Endpoint at SCG | O | |
| >>>>Secondary SgNB DL GTP Tunnel Endpoint at SCG | O | |
| >>>>RLC Status | O | |
| E-RABs Admitted To Be Released List | | 0 . . . 1 |
| >E-RABs Admitted To Be Released Item | | 1 . . . <maxnoofBearers> |
| >>E-RAB ID | M | |
| >>EN-DC Resource Configuration | M | |
| >>CHOICE Resource Configuration | M | |
| E-RABs Not Admitted List | O | |
| SgNB to MeNB Container | O | |
| Criticality Diagnostics | O | |
| MeNB UE X2AP ID Extension | O | |
| SgNB Resource Coordination Information | O | |
| Admitted split SRBs | O | |
| Admitted split SRBs release | O | |
| RRC config indication | O | |
| Location Information at SgNB | O | |
| Available fast MCG recovery via SRB3 | O | |
| Release fast MCG recovery via SRB3 | O | |
| Request Reconfiguration Complete | O | ENUMERATED {true, . . . } |
| | | Indicates that the SN is |
| | | waiting for information |
| | | on whether the UE |
| | | reconfiguration is |
| | | successful or not. |

“Interactions with the SgNB Reconfiguration Completion procedure” in Section 8.7.6 “MeNB initiated SgNB Modification Preparation” of 3GPP TS 36.423 may be described as:

“If the en-gNB admits a modification of the UE context requiring the MeNB to report about the success of the RRC connection reconfiguration procedure, the en-gNB shall inform the MeNB by including the Request Reconfiguration Complete IE in the SGNB MODIFICATION REQUEST ACKNOWLEDGE message and start the timer T_{DCoverall} when sending the SGNB MODIFICATION REQUEST ACKNOWLEDGE message to the MeNB. The reception of the SGNB RECONFIGURATION COMPLETE message shall stop the timer T_{DCoverall}.”

Similar description may be added in XnAP standard (3GPP TS 38.423).

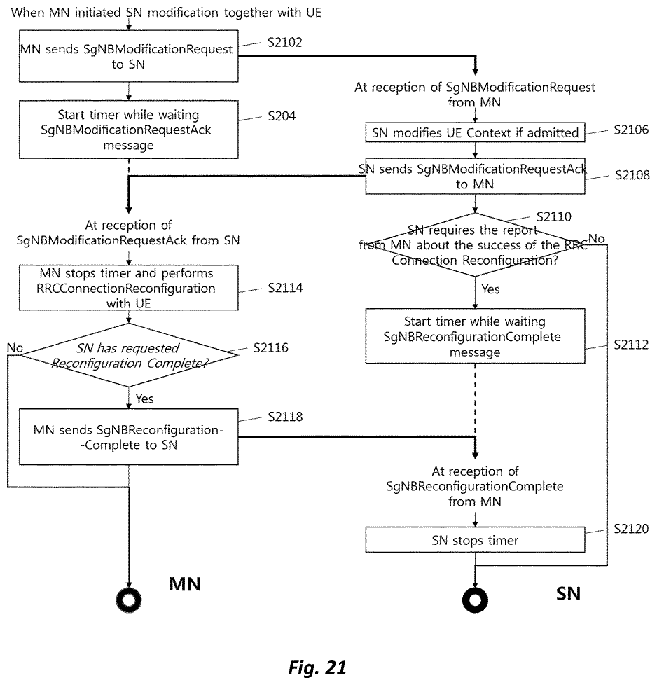

Examples of the methods for enhanced SN modification procedure will be described in more details with reference to FIGS. 21 to 24 and the above Table 1. FIG. 21 shows a legacy flow of the MN initiated SN Modification procedure in the EN-DC scenario shown in FIG. 4. This MN initiated SN Modification procedure in the EN-DC scenario is just an example, and SN Modification procedures in other DC scenarios may also apply, for example, the MN initiated SN Modification procedure in MR-DC with 5GC.

As shown in FIG. 21, when the MN (e.g., MeNB) initiated SN modification together with UE, the MN sends SgNBModificationRequest message to the SN (e.g., SgNB) (S2102). Then, the MN starts a timer while waiting for SgNBModificationRequestAcknowledge message (S2104). At reception of SgNBModificationRequest message from the MN, the SN modifies UE context if admitted (S2106), and sends SgNBModificationRequestAcknowledge message to the MN (S2108). The SN also checks whether it requires a report from the MN about a success of RRC Connection Reconfiguration with the UE (S2110). If Yes, the SN starts a timer T_{DCoverall} while waiting for SgNBReconfigurationComplete message from the MN (S2112). If No, the operation of SN ends. At the MN side, up reception of the SgNBModificationRequestAcknowledge message from the SN, the MN stops the timer and performs RRC Connection Reconfiguration with UE (S2114). Then, the MN checks whether the SN has requested the SgNBReconfigurationComplete message (S2116). If Yes, the MN sends the SgNBReconfigurationComplete message to SN (S2118). If No, the operation of MN ends. At the SN side, upon reception of the SgNBReconfigurationComplete message from the MN, the SN stops the timer T_{DCoverall} (S2120), and the operation ends.

In the above legacy flow, the SN may contain in the the SgNBModificationRequestAcknowledge message a configuration that requires synchronization with the UE or just information elements (e.g. PDCP configuration for an SN terminated bearer) and send the message to the MN at S2108. In the former case, it may be obvious for the MN to check (S2116) that the SgNBReconfigurationComplete message needs to be sent to the SN to report the success of UE reconfiguration, in order for synchronization with the UE. However, in the latter case, it is not obvious for the MN to make such check, and the sending of the SgNBReconfigurationComplete message may be unnecessary. That is, it is not clearly stated when or in which case the MN should send SgNBReconfigurationComplete message to the SN. So the MN and the SN may have different understanding of the UE context, and it may result in unintended operations.

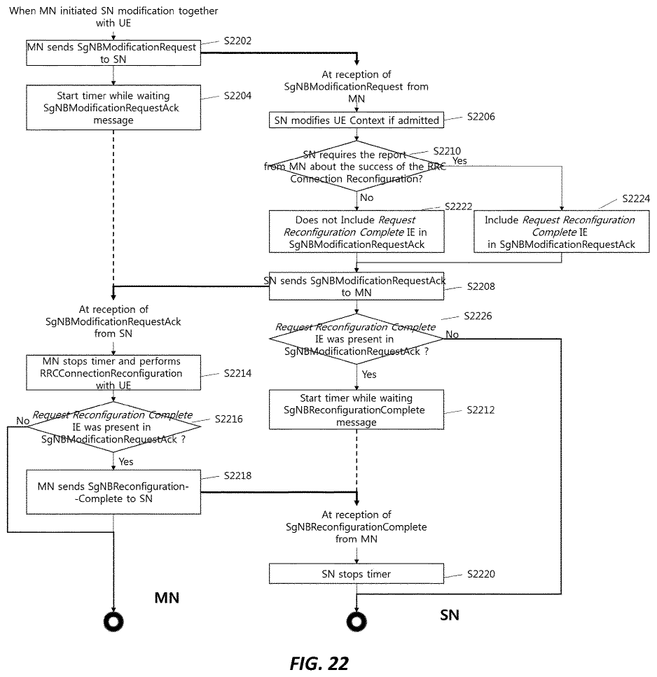

FIG. 22 shows an example flow of an MN initiated SN Modification procedure in the EN-DC scenario according to some embodiments of the present disclosure. Operations S2202, S2204, S2206, S2210, S2214 and S2220 are the same as operations S2102, S2104, S2106, S2110, S2114 and S2120 of FIG. 21, and repeated description thereof will be omitted here.

When the SN checks that it requires a report from the MN about a success of RRC Connection Reconfiguration with the UE (S2210, Yes), the SN includes an indication indicating that information on whether the UE reconfiguration is successful is required from the MN (e.g., the Request Reconfiguration Complete IE), in the SgNBModificationRequestAcknowledge message (S2224); otherwise, when the SN checks that it does not require a report from the MN about a success of RRC Connection Reconfiguration with the UE (S2210, No), the SN does not include the indication in the SgNBModificationRequestAcknowledge message (S2222). Then, the SN sends the SgNBModificationRequestAcknowledge message to the MN (S2208). Upon sending the message, the SN checks whether the Request Reconfiguration Complete IE was present in the sent SgNBModificationRequestAcknowledge message (S2226). If Yes, the SN starts a timer T_{DCoverall} while waiting for SgNBReconfigurationComplete message from the MN (S2212). If No, the operation of SN ends. At the MN side, the MN checks whether the Request Reconfiguration Complete IE was present in the SgNBModificationRequestAcknowledge message received from the SN (S2216). If Yes, the MN sends the SgNBReconfigurationComplete message to SN (S2218). If No, the operation of MN ends.

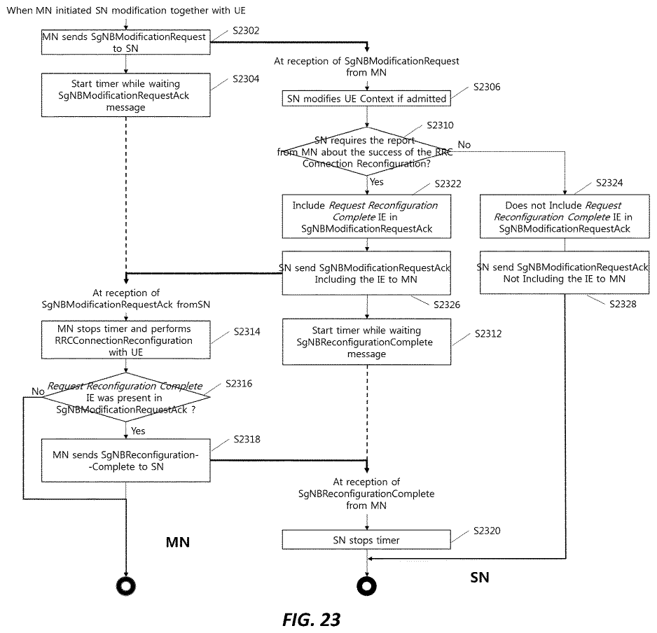

FIG. 23 shows another example flow of an MN initiated SN Modification procedure in the EN-DC scenario according to some embodiments of the present disclosure. Operations S2302, S2304, S2306, S2310, S2312, S2314, S2316, S2318, S2320, S2324 and S2322 are the same as operations S2202, S2204, S2206, S2210, S2212, S2214, S2216, S2218, S2220, S2222 and S2224 of FIG. 22 respectively, and repeated description thereof will be omitted here.

In the case that the SN includes an indication indicating that information on whether the UE reconfiguration is successful is required from the MN (e.g., the Request Reconfiguration Complete IE), in the SgNBModificationRequestAcknowledge message (S2322), the SN sends the message including the Request Reconfiguration Complete IE to the MN (S2326), and starts a timer T_{DCoverall} while waiting for SgNBReconfigurationComplete message from the MN (S2312). In the case that the SN does not include the Request Reconfiguration Complete IE in the SgNBModificationRequestAcknowledge message (S2324), the SN sends the message not including the IE to the MN (S2328), and the flow ends.

Compared with the legacy flow of FIG. 21, in the flows of FIGS. 22 and 23, the SN optionally includes, in the SN Modification Request Acknowledge message to be sent to the MN, an indication indicating that information on whether the UE reconfiguration is successful is required from the MN. At the MN side, the MN checks whether the indication was present in the SN Modification Request Acknowledge message received from the SN. If yes, the MN knows that it should send the SN Reconfiguration Complete message to SN; if no, the MN knows that it does not need to send the SN Reconfiguration Complete message. In this way, the MN can clearly know if the SN is waiting for information on whether the UE reconfiguration is successful or not, and it is possible for the MN to send SN Reconfiguration Complete message only if required. As a result, both of the MN and SN can have the same understanding of the UE context, so this can avoid unintended operations (for example, reducing unnecessary message transmission for checking each other's understanding of the UE context via X2 or Xn interface), and guarantee continuity of service to the UE by preventing unintended EN-DC release or UE release.

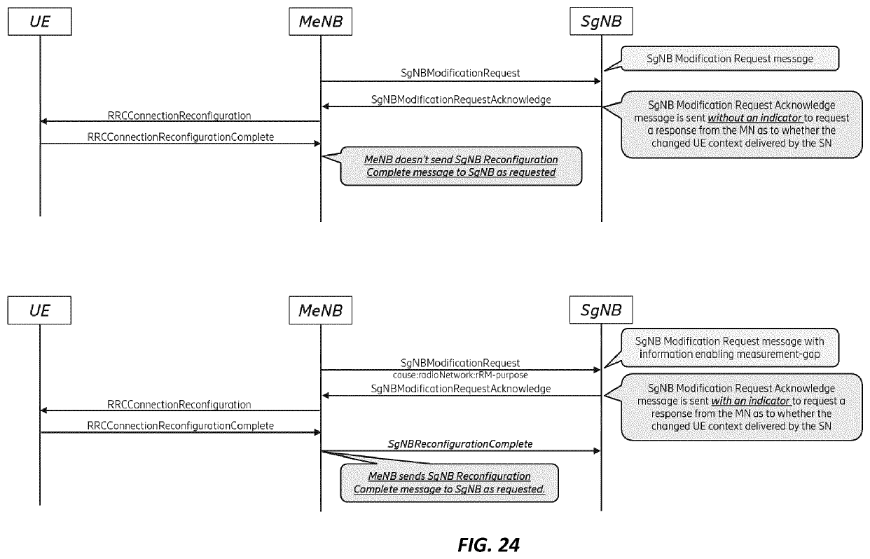

FIG. 24 shows signalling between UE, MeNB and SgNB in an SN modification procedure according to some embodiments of the present disclosure. The upper part of FIG. 24 shows that the SgNB does not includes, in a SgNBModificationRequestAcknowledge message, an indicator to request a response from the MN as to whether the changed UE context delivered by the SN has been well applied to UE. Then, based on the received SgNBModificationRequestAcknowledge message without the indicator, the MeNB does not send a SgNBReconfigurationComplete to the SgNB. The lower part of FIG. 24 shows that the MeNB sends a SgNBModificationRequest message to the SgNB with information enabling measurement gap. After reception of such SgNBModificationRequest message, the SgNB includes, in the SgNBModificationRequestAcknowledge message, an indicator to request a response from the MN as to whether the changed UE context delivered by the SN has been well applied to UE. Then, based on the received SgNBModificationRequestAcknowledge message with the indicator, the MeNB knows and sends a SgNBReconfigurationComplete to the SgNB after the changed UE context has been applied to UE.

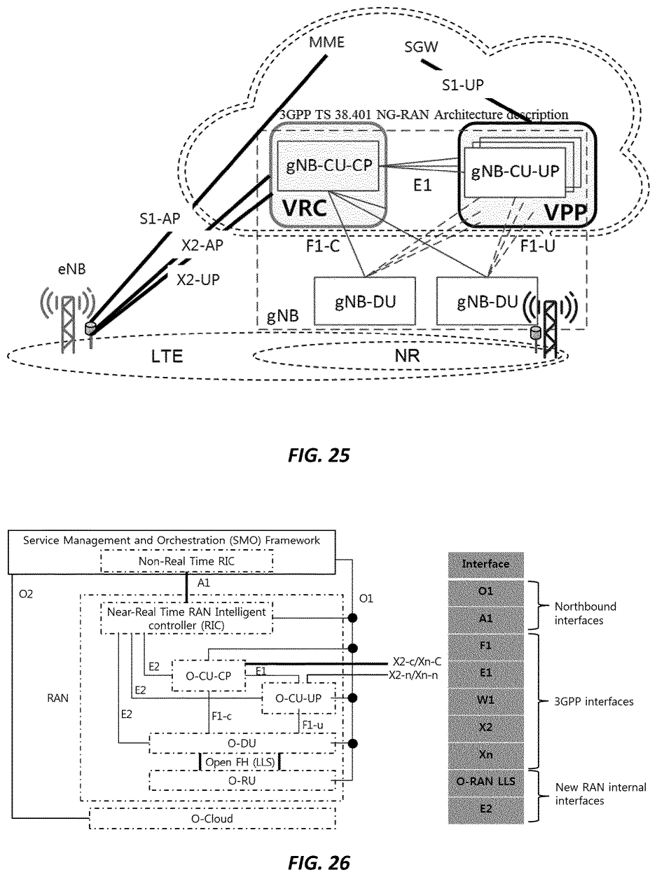

Solutions provided herein are more about message and interface between 3GPP network entities (such as UE, eNB and gNB), and independent from how the RAN (e.g., eNB, gNB) is deployed. The solutions can work regardless of deployment type-embedded deployment or split deployment in cloud. In case of split deployment, one of (or both) the eNB and gNB can be deployed in Cloud as virtualized RAN, and in case of embedded deployment, the eNB and gNB can be deployed in a radio node in site. FIG. 25 is a schematic diagram of gNB split deployment in cloud implementation. Reference may also be made to 3GPP TS 38.401 NG-RAN; Architecture description, in particular, “Overall architecture for separation of gNB-CU-CP and gNB-CU-UP.” A gNB may consist of a gNB-CU-CP, multiple gNB-CU-UPs and multiple gNB-DUs. The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface. In FIG. 25, the gNB-CU-CP is instantiated to VRC and the gNB-CU-UP is instantiated to VPP. The enhanced SN modification behavior of the present disclosure may work on gNB-CU-CP (VRC) in cloud environment.

FIG. 26 is a schematic diagram of O-RAN implementation in which some embodiments of the present disclosure may be applied. FIG. 26 shows the overall architecture of O-RAN (reference may also be made to Technical Specification “O-RAN Architecture Description 7.0,” in particular “Overall Architecture of O-RAN”) and interfaces including 3GPP interfaces. Solutions provided herein may work in Central Unit/Control Plane (CU-CP) introducing new information element to the already open-standardized XnAP/X2AP messages conveyed through the X2-C/Xn-C interface between RANs. The solutions can work regardless of the deployment and identically working in O-RAN as well. No specific handling or exceptional handling is needed for O-RAN Implementation.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

1. A method performed by a second network node, the method comprising:
including in a Secondary Node (SN) Modification Request Acknowledge (SNMRA) message an indication indicating that information on whether a user equipment (UE) reconfiguration of a UE is successful is required from a first network node; and
sending the SN Modification Request Acknowledge message to the first network node, wherein
the first network node and the second network node comprise a master node (MN) and a secondary node (SN), respectively, in dual connectivity with the UE.

2. The method of claim 1, wherein
the method further comprises, prior to including the indication in the SNMRA message, determining whether the information is required from the first network and
the second network node includes the indication in the SNMRA message as a result of determining that the information is required from the first network node.

3. The method of claim 2, wherein
the method further comprises receiving, from the first network node, a SN Modification Request message, and
determining whether the information is required from the first network node comprises:
determining that the information is required if the second network node admits a modification of UE context based on the SN Modification Request message.

4. The method of claim 1, wherein
the method further comprises receiving an SN Reconfiguration Complete message that is sent from the first network node in response to receiving the SN Modification Request Acknowledge message, and
the SN Reconfiguration Complete message indicates a success of the UE reconfiguration.

5. (canceled)

6. The method of claim 1, wherein the method further comprises:
starting a timer upon sending the SN Modification Request Acknowledge message including the indication.

7. The method of claim 1, wherein the method further comprises:
upon sending the SN Modification Request Acknowledge message, checking whether the indication is included in the SN Modification Request Acknowledge message; and
starting a timer if the indication is included in the SN Modification Request Acknowledge message.

8. The method of claim 6, wherein the method further comprises:
stopping the timer upon receiving an SN Reconfiguration Complete message from the first network node.

9. The method of claim 1, wherein the indication comprises an information element in a form of a bit or field in the SN Modification Request Acknowledge message.

10. The method of claim 1, wherein
the method is performed as part of an MN initiated modification procedure; and/or
each of the SN Modification Request message, the SN Modification Request Acknowledge message and the SN Reconfiguration Complete message comprises a message over X2/Xn interface between the SN and MN configured for dual connectivity.

11. The method of claim 1, wherein:
the second network node has its own Radio Resource Control (RRC) entity that can generate an RRC Protocol Data Unit (PDU) to be sent to a UE in the dual connectivity, and/or
the second network node is a virtualized Radio Access Network (RAN) in case of split deployment, or as a network node in site in case of embedded deployment.

12. The method of claim 1, wherein the method can be performed in Central Unit/Control Plane (CU-CP) with XnAP/X2AP messages conveyed through X2-C/Xn-C interface between Radio Access Networks (RANs) in an Open-RAN (O-RAN) implementation.

13. A method performed by a first network node, the method comprising:
receiving a Secondary Node (SN) Modification Request Acknowledge (SNMRA) message from a second network node; and
checking whether an indication indicating that information on whether a user equipment (UE) reconfiguration of a UE is successful is required from the first network node is included in the SN Modification Request Acknowledge message, wherein
the first network node and the second network node comprise a master node (MN) and a secondary node (SN), respectively, in dual connectivity with the UE.

14. The method of claim 13, wherein the method further comprises:
initiating a UE reconfiguration procedure in response to receiving the SN Modification Request Acknowledge message; and
wherein checking whether the indication is included in the SN Modification Request Acknowledge message comprises:
checking whether the indication is included in the SN Modification Request Acknowledge message upon a successful completion of the UE reconfiguration.

15. The method of claim 13, wherein the method further comprises:
as a result of determining that the indication is included in the SN Modification Request Acknowledge message, sending an SN Reconfiguration Complete message to the second network node.

16. The method of claim 15, wherein the SN Reconfiguration Complete message is sent to indicate to the second network node a success of the UE reconfiguration.

17. The method of claim 13, wherein the indication comprises an information element in a form of a bit or field in the SN Modification Request Acknowledge message.

18. The method of claim 13, wherein the method is performed as part of an MN initiated modification procedure; and/or
wherein each of the SN Modification Request Acknowledge message and the SN Reconfiguration Complete message comprises a message over X2/Xn interface between the SN and MN configured for dual connectivity.

19. The method of claim 13, wherein:
the first network node has its own Radio Resource Control (RRC) entity that can generate an RRC Protocol Data Unit (PDU) to be sent to a UE in the dual connectivity; and/or
the first network node is deployed in Cloud as virtualized Radio Access Network (RAN) in case of split deployment, or as a network node in site in case of embedded deployment.

20. The method of claim 13, wherein the method can be performed in Central Unit/Control Plane (CU-CP) with XnAP/X2AP messages conveyed through X2-C/Xn-C interface between Radio Access Networks (RANs) in an Open-RAN (O-RAN) implementation.

21. A network node comprising:
processing circuitry comprising one or more processors; and
memory storing instructions that, when executed by the processing circuitry causes the network node to perform a method comprising:
including in a Secondary Node (SN) Modification Request Acknowledge (SNMRA) message an indication indicating that information on whether a user equipment (UE) reconfiguration of a UE is successful is required from a first network node; and
sending the SN Modification Request Acknowledge message to the first network node, wherein
the first network node and the second network node comprise a master node (MN) and a secondary node (SN), respectively, in dual connectivity with the UE.

22. (canceled)
